(19) United States
(12) Patent Application Publication
(10) Pub. No.: US 2026/0208369 A1
(43) Pub. Date: Jul. 23, 2026

(54) HAND AND COMPONENT SUPPLY SYSTEM INCLUDING SAME

(71) Applicant: NTN CORPORATION, OSAKA (JP)

(72) Inventors: Toshiki TAKAKI, Iwata (JP); Naoki MARUI, Iwata (JP)

(73) Assignee: NTN CORPORATION, OSAKA (JP)

(21) Appl. No.: 19/559,586

(22) Filed: Mar. 6, 2026

Related U.S. Application Data
(63) Continuation of application No. PCT/JP2024/030863, filed on Aug. 29, 2024.

(30) Foreign Application Priority Data
Sep. 8, 2023 (JP) 2023-145893
Mar. 18, 2024 (JP) 2024-042355

(51) Int. Cl. B25J 15/00

(52) U.S. Cl. CPC B25J 15/0028

(57) ABSTRACT

A hand according to the present invention includes a pair of claws moving in an open-close direction that grip or release a workpiece and a gripping portion which moves the claw in the open-close direction. The claw is supported at its base end by the gripping portion so as to be movable in the open-close direction, extends in a longitudinal direction from the gripping portion, and has a gripping surface gripping the workpiece at its tip end. The gripping surface has a first inclined surface and a second inclined surface. A tip end side angle is set to be smaller than a base end side angle.

### CROSS REFERENCE TO THE RELATED APPLICATION

This application is a continuation application, under 35 U.S.C. § 111(a) of international patent application No. PCT/JP2024/030863, filed Aug. 29, 2024, which claims priority to a Japanese patent application No. 2023-145893 filed Sep. 8, 2023 and a Japanese patent application No. 2024-042355 filed Mar. 18, 2024, the entire disclosure of all of which are herein incorporated by reference as a part of this application.

### BACKGROUND OF THE INVENTION

### Field of the Invention

The present invention relates to a component supply system including a parts feeder that feeds workpieces such as mechanical components, electronic components, or other components to a conveyance carrier and a robot that picks up the workpieces on the conveyance carrier and feeds them to the next process, and especially relates to a hand including a gripping portion that grips and releases a workpiece.

### Description of Related Art

A device has been known in which claws provided at a tip end of a hand can grip workpieces such as bolts, electronic components, or other components (for example, Patent Documents 1 and 2). In the device of Patent Document 1, a workpiece gripping surface of the claw is flat. In addition, in the device of Patent Document 2, a notch fitting a shape of a workpiece is provided on a gripping surface of the claw, and the claws fitting multiple shapes of workpieces are rotatably provided at the tip end of the hand. By rotating the claws themselves, multiple types of workpieces can be lifted and transported.
[Patent Document 1] JP Laid-open Patent Publication No. 2002-283268
[Patent Document 2] JP Patent No. 5,408,186

### SUMMARY OF THE INVENTION

However, when the claws of Patent Document 1 whose gripping surfaces are flat grip columnar-or cylindrical-shaped workpieces such as bolts or pins, the workpieces easily slip on the gripping surface and may fall. Thus, the claws often cannot lift the workpieces and the workpieces easily fall when transported. Since the claws of Patent Document 2 require a rotational mechanism for rotating the claws on the hand, the number of components increases, which makes the configuration complicated. Further, when the workpiece is fed with its posture inclined, it is necessary to detect the posture of the workpiece and control a rotational angle. As a result, a sensor and a controller are needed, and thus the configuration becomes complicated.

An object of the present invention is to provide a hand and a component supply system including the same which, with a simple configuration, can stably pick up cylindrical workpieces inclined slightly to a conveyance carrier and cylindrical workpieces having different diameters.

A hand according to the present invention includes: a claw that grips or releases a workpiece; and a gripping portion which moves the claw in a gripping direction for gripping the workpiece and in a releasing direction for releasing the workpiece. The claw is supported at its base end by the gripping portion so as to be movable in the gripping direction and the releasing direction, extends in a longitudinal direction from the gripping portion, and has a gripping surface gripping the workpiece at its tip end. The gripping surface has: a first inclined surface which extends in an inclined condition in the releasing direction from its base end in the longitudinal direction toward a tip end side in the longitudinal direction; and a second inclined surface which extends in an inclined condition in the releasing direction from its tip end in the longitudinal direction toward a base end side in the longitudinal direction so as to be continued to the first inclined surface. Seen in an orthogonal direction which is orthogonal to each of the longitudinal direction, the gripping direction and the releasing direction, a tip end side angle α between a tip end side virtual line drawn by extending the second inclined surface to the tip end side and a horizontal conveyance surface of the conveyance carrier is set to be smaller than a base end side angle β between a base end side virtual line drawn by extending the first inclined surface to the base end side and a parallel line parallel to the conveyance surface (α<β).

According to this configuration, reducing the tip end side angle α makes it easier to scoop up workpieces inclined slightly to the conveyance carrier. In addition, increasing the base end side angle β makes larger an inclination angle γ between the first inclined surface and the second inclined surface. Accordingly, a tangent line between the four inclined surfaces of the claws and a cylindrical workpiece becomes closer to the point where the first inclined surface and the second inclined surface are connected. Thus, even when the diameter of a cylindrical workpiece increases, it is possible to pick up the workpiece so that the four inclined surfaces form a tangent plane. Therefore, it is also possible to stably pick up cylindrical workpieces having different diameters. Accordingly, in addition to a cylindrical workpiece placed horizontally to the conveyance carrier, it is also possible to stably pick up cylindrical workpieces inclined slightly to the conveyance carrier and cylindrical workpieces having different diameters. Further, since it is not necessary to provide a rotational mechanism of the claw and a sensor for detecting the posture of the workpiece, the configuration becomes simple.

In this case, the tip end side angle α may be set to be 25° or more and 30° or less, and the base end side angle β may be greater than 50° and smaller than 60°, i.e., 25°≤α≤30° and 50°<β<60°. When the tip end side angle α is smaller than 25°, the tip end becomes thinner, which reduces rigidity. In addition, when the tip end side angle α is greater than 30°, it becomes difficult to scoop up the workpieces inclined slightly to the conveyance carrier. The base end side angle β is set so that the inclination angle γ is adjusted to an outer diameter of the cylindrical workpiece. The simulation has confirmed that setting the base end side angle β to be greater than 50° and smaller than 60° makes it possible to stably pick up a cylindrical workpiece having a desired outer diameter.

In the present invention, a friction coefficient of at least one of the first inclined surface and the second inclined surface may be 0.2 or less. This makes it easier for the workpiece to move along the inclined surface and enables to grip the cylindrical workpieces inclined slightly to the conveyance carrier at the stable position where the four inclined surfaces form a tangent plane.

Further, in the present invention, a rotation transmission mechanism may be provided to rotate the workpieces gripped by the claw about a rotational axis parallel to the gripping direction and the releasing direction. According to this configuration, since the rotation transmission mechanism is provided to rotate the workpiece gripped by the claw about the rotational axis parallel to the gripping direction and the releasing direction, it is possible to stably move and place the workpiece regardless of its posture when picked up.

In the present invention, the rotation transmission mechanism may include: a rotational portion provided at the tip end of the claw to be rotatable to the claw about the rotational axis parallel to the open-close direction; and a second driving source which rotatably drives the rotational portion about the rotational axis, and the gripping surface may be formed on the rotational portion. According to this configuration, since the workpiece is rotatable about the rotational axis parallel to the open-close direction by the rotational portion, the posture of the workpiece can be changed while the workpiece is gripped. This can shorten operation time.

In this case, the rotation transmission mechanism and the claws may be integrated to form a sub-assembly, and the sub-assembly may be attached to the gripping portion. According to this configuration, the claws having the rotation transmission mechanism can be applied to an existing gripping portion. In particular, it is easy to adjust the size of the gripping mechanism and the length of the claw, which provides high versatility.

When the rotational portion and the second driving source are provided, the rotation transmission mechanism may further include: a power transmission mechanism that is connected to at least one of the rotational portions, moves with the rotational portion in the gripping direction and the releasing direction and transmits the power of the second driving source to the rotational portion; and a telescopic rotational mechanism that is telescopic in the gripping direction and the releasing direction and transmits rotation of the second driving source to the power transmission mechanism.

According to this configuration, the rotational portion of the rotation transmission mechanism is separately provided at the tip end of the claw attached to the gripping portion and rotates the workpiece about the rotational axis parallel to the gripping direction and the releasing direction of the claw. The rotational portion is rotated by the power of the second driving source that is independent of the power for opening and closing the claw. Accordingly, even when the heights of the workpieces to be gripped during set-up change are different, it is sufficient to replace the claw and the rotation transmission mechanism supported by the claw, i.e., there is no need to replace the gripping portion. As a result, the length from the root of the claw to the rotational axis can be easily changed.

Moreover, the second driving source does not move with the claw in the gripping direction and the releasing direction. Thus, since the load in the gripping direction and the releasing direction is reduced, the claw can be operated at high speed. In addition, since only the rotational portion is rotated rather than the entire gripping portion, the objects to be rotated are limited to the workpiece and the rotational portion. This reduces the weight and the moment of inertia of the objects to be rotated. Consequently, it is possible to achieve high-speed rotation of the rotational portion and low torque of the second driving source, which makes it possible to reduce the size and weight of the second driving source.

When the power transmission mechanism and the telescopic rotational mechanism are provided, the telescopic rotational mechanism may include: a first rotational shaft connected to an output shaft of the second driving source; a second rotational shaft connected to an inlet rotating body of the power transmission mechanism; and a telescopic rotational structure that transmits rotation of the first rotational shaft to the second rotational shaft and supports the second rotational shaft movably in the gripping direction and the releasing direction relative to the first rotational shaft.

In this case, the telescopic rotational structure may include: a cylindrical outer member provided on either a shaft end of the first rotational shaft or the second rotational shaft; an inner member provided on another shaft end of the first rotational shaft or the second rotational shaft and inserted into a hollow hole of the outer member; and a rolling element interposed between the outer member and the inner member, the rolling element transmitting rotation of the outer member to the inner member and supporting the member provided on the second rotational shaft movably in the gripping direction and the releasing direction relative to the member provided on the first rotational shaft. According to this configuration, it is possible to securely transmit rotational torque in a rotational direction and to move smoothly in a telescopic direction with low resistance.

Alternatively, the telescopic rotational structure may include: first gear provided on either the first rotational shaft or the second rotational shaft that has an axial dimension longer than an open-close width of the gripping portion; and a second gear provided on another of the first rotational shaft and the second rotational shaft, the second gear transmitting rotation of the first gear by meshing with the first gear and being movable in the gripping direction and the releasing direction relative to the first gear. According to this configuration, with a small number of components, it is possible to securely transmit rotational torque in the rotational direction and to move in the telescopic direction.

A component supply system of the present invention may include: a parts feeder that feeds the workpiece to a conveyance carrier; a robot that conveys the workpiece from a first area where the conveyance carrier is located to a second area different from the first area; and a hand of the present invention attached to a tip end of an arm of the robot, the hand picking up the workpiece on the conveyance carrier at the first area and placing them on the second area.

According to this configuration, since a posture of a gripping portion of the hand is changeable, it is possible to prevent the hand from coming into contact with other workpieces or equipment when the workpieces on the conveyance carrier are picked up. As a result, it is possible to prevent malfunction of the hand or other equipment and also to improve work efficiency.

The component supply system of the present invention may further include: a workpiece detector that detects a position and posture of the workpiece on the conveyance carrier; and a controller that synchronously controls the robot and the hands. The controller may move the arm of the robot to the position detected by the workpiece detector and make the hand grip the workpiece at an angle corresponding to the posture detected by the workpiece detector.

Any combination of at least two constructions, disclosed in the appended claims and/or the specification and/or the accompanying drawings should be construed as included within the scope of the present invention. In particular, any combination of two or more of the appended claims should be equally construed as included within the scope of the present invention.

### BRIEF DESCRIPTION OF THE DRAWINGS

In any event, the present invention will become more clearly understood from the following description of preferred embodiments thereof, when taken in conjunction with the accompanying drawings. However, the embodiments and the drawings are given only for the purpose of illustration and explanation, and are not to be taken as limiting the scope of the present invention in any way whatsoever, which scope is to be determined by the appended claims. In the accompanying drawings, like reference numerals are used to denote like parts throughout the several views, and:

FIG. 1 is a top plan view of a component supply system including a hand according to a first embodiment of the present invention;

FIG. 2 is a side view of the component supply system;

FIG. 3 is a perspective view illustrating the component supply system;

FIG. 4 is a cross-sectional view illustrating a groove that is type of a posture stabilizer of the component supply system;

FIG. 5A is an enlarged front view of a hand of the component supply system;

FIG. 5B is a side view of the hand of FIG. 5A viewed from the direction of the arrow VB;

FIG. 6A is a front view illustrating a hand in a posture different from that of FIG. 5A;

FIG. 6B is a side view of the hand of FIG. 6A viewed from the direction of the arrow VIB;

FIG. 7A is a front view illustrating the hand before picking a bolt-shaped workpiece;

FIG. 7B is a side view of the hand of FIG. 7A viewed from the direction of the arrow VIIB;

FIG. 7C is a rear view of the hand of FIG. 7B viewed from the direction of the arrow VIIC;

FIG. 8A is a front view of the hand in which the bolt-shaped workpiece is picked up;

FIG. 8B is a side view of the hand of FIG. 8A viewed from the direction of the arrow VIIIB;

FIG. 8C is a rear view of the hand of FIG. 8B viewed from the direction of the arrow VIIIC;

FIG. 9 is a front view illustrating a claw of the hand;

FIG. 10A is a front view illustrating a variation of the hand;

FIG. 10B is a perspective view illustrating the hand;

FIG. 11A is a front view illustrating the hand according to a second embodiment of the present invention;

FIG. 11B is a side view of the hand of FIG. 11A viewed from the direction of the arrow XIB;

FIG. 12 is a longitudinal cross-sectional view illustrating the hand;

FIG. 13A is a perspective view illustrating a telescopic rotational mechanism of the hand;

FIG. 13B is a side view illustrating the telescopic rotational mechanism;

FIG. 13C is a cross-sectional view along a XIIIC-XIIIC line FIG. 13B;

FIG. 14 is a front view illustrating a variation of the telescopic rotational mechanism of the hand;

FIG. 15 is a front view illustrating a variation of the hand;

FIG. 16A is a front view illustrating another variation of the hand;

FIG. 16B is a side view of the hand of FIG. 16A viewed from the direction of the arrow XVIB;

FIG. 17A is a front view illustrating a hand according to a reference example;

FIG. 17B is an enlarged view of a XVIIB portion of FIG. 17A;

FIG. 18A is front view illustrating the hand before picking up the bolt-shaped workpiece; and

FIG. 18B is a side view of the hand of FIG. 18A viewed from the direction of the arrow XVIIIB.

### DESCRIPTION OF EMBODIMENTS

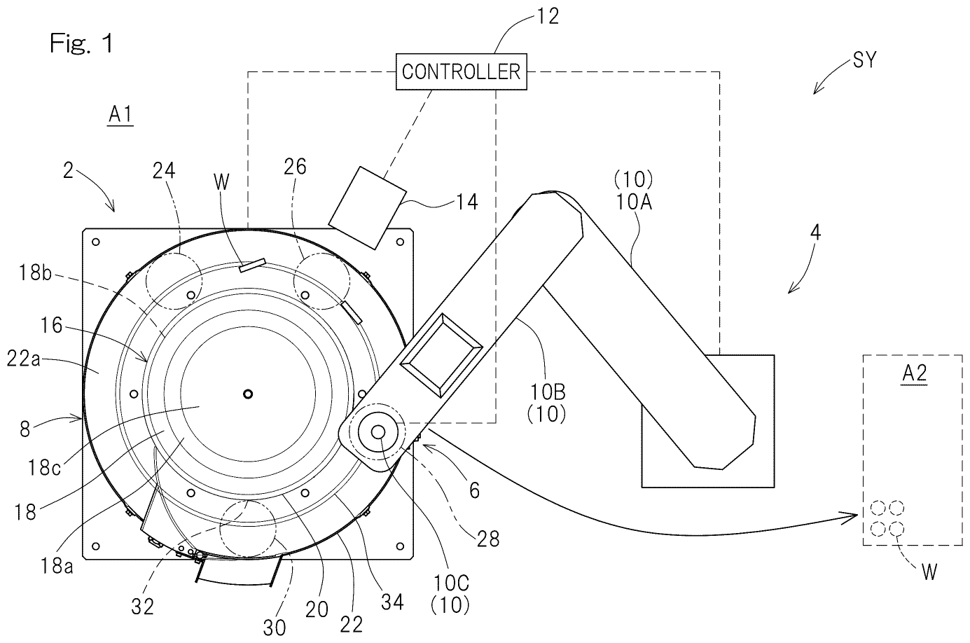

Favorable embodiments of the present invention will be described in lights of Figures. FIGS. 1-3 are a cross-sectional view, a side view and a perspective view of a component supply system SY according to a first embodiment of the present invention. In the following description, the “upstream” and the “downstream” refer to the “upstream” and the “downstream” in a flow direction of a workpiece.

### Whole System

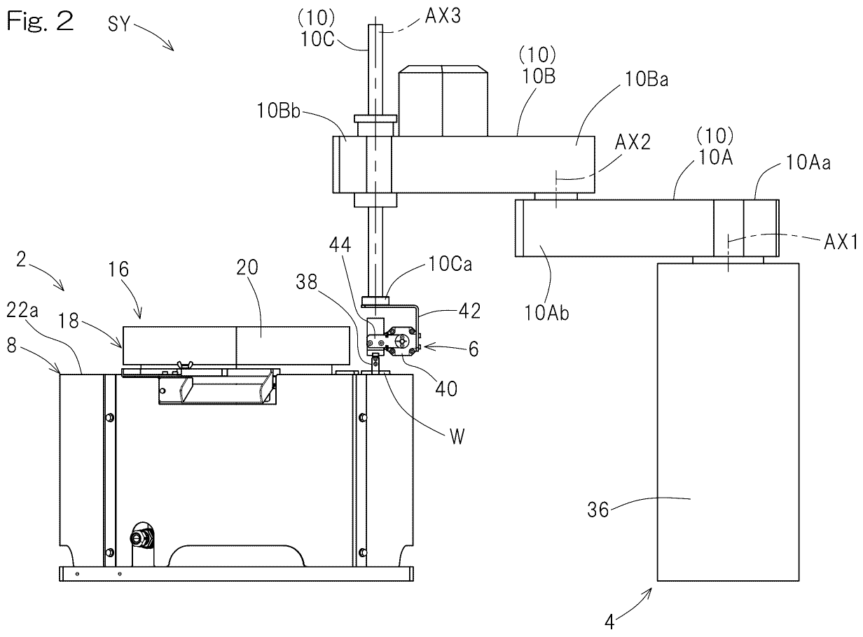

As shown in FIG. 1, a component supply system SY picks u a workpiece W, that is automatically aligned by a parts feeder 2, with a robot 4 and a hand 6 (FIG. 2) and feeds it to an automatic machine for the next process. In detail, the component supply system SY includes: the parts feeder 2 that feeds the workpiece W to a conveyance carrier 8; the robot 4 that conveys the workpieces W from a first area A1 where the conveyance carrier 8 is located to a second area A2 different from the first area A1; and the hand 6 (FIG. 2) attached to a tip of an arm 10 of the robot 4.

In this embodiment, the workpiece W is a cylindrical member such as a bolt. However, the workpiece W is not limited to this, but may be, for example, machine parts, electronic parts, plastic parts, medicines, medical supplies, foods, or miscellaneous goods.

A controller 12 synchronously controls the parts feeder 2, the robot 4 and the hand 6. Specifically, a workpiece detector 14 detects the position and posture of the workpiece W on the conveyance carrier 8, the arm 10 of the robot 4 moves to the position detected by the workpiece detector 14, and the hand 6 grips the workpiece W at an angle corresponding to the posture detected by the workpiece detector 14. Then, the arm 10 of the robot 4 moves to the second area A2, and the hand 6 releases the workpiece W. Thereafter, this operation is repeated.

In this embodiment, the workpiece detector 14 is a photographing device such as a camera. However, the workpiece detector 14 is not limited to a camera, but may be, for example, a distance sensor or a contact-type one. The camera may be provided only for detecting the position and posture of the workpiece W or may be used for other purposes as well. Further, the camera may be fixed and attached to the arm 10 of the robot 4.

### Parts Feeder

The parts feeder 2 includes: a vibrating bowl feeder 16 aligning the stored workpiece W by vibration; and the conveyance carrier 8 that conveys the aligned workpiece W fed from the vibrating bowl feeder 16. The conveyance carrier 8 is arranged so as to surround an outer periphery of the vibrating bowl feeder 16 along the outer periphery of the vibrating bowl feeder 16.

The vibrating bowl feeder 16 includes: a bowl 18 having a conveying path 18a on its inner peripheral surface; and a vibrator (not illustrated) that vibrates the bowl 18. The workpiece W stored in the bowl 18 is aligned by vibration of the vibrator and sequentially conveyed along the conveying path 18a to a workpiece discharging section 18b located at the uppermost position of the conveying path 18a.

The parts feeder 2 of this embodiment includes a standing wall 20 protruding above an upper surface of the conveyance carrier 8 over the entire periphery between the vibrating bowl feeder 16 and the conveyance carrier 8. In other words, the standing wall 20 is located radially outside the vibrating bowl feeder 16 and radially inside the conveyance carrier 8.

The workpiece discharging section 18b and a workpiece recovering portion 32 described below are openings that penetrate the standing wall 20. However, the configuration of the parts feeder 2 is not limited to this. An area without the standing wall 20 may be formed partially or entirely in a circumferential direction between the vibrating bowl feeder 16 and the conveyance carrier 8. In this case, the workpiece discharging section 18b and the workpiece recovering portion 32 (described below) may be formed in an area without the standing wall 20 in the circumferential direction of the conveyance carrier 8.

The bowl 18 includes: a bottom 18c for storing the workpiece W; and the conveying path 18a that spirals upward from an outer diameter side of the bottom 18c. The workpiece discharging section 18b that penetrates the standing wall 20 is formed at the uppermost position of the conveying path 18a.

The workpiece put into the bottom 18c of the bowl 18 is aligned and sequentially fed out from the lower side to the upper side of the conveying path 18a on the inner peripheral surface by vibration of the bowl 18. Then, the workpiece W is ejected from the workpiece discharging section 18b located at the uppermost position of the conveying path 18a.

The conveyance carrier 8 is arranged in an annular shape along the outer periphery of the vibrating bowl feeder 16. The conveyance carrier 8 has a rotating disk 22 having an upper surface which forms an annular-shaped conveyance surface 22a of the workpiece W. The conveyance surface 22a and the workpiece discharging section 18b are adjusted at the approximately same height. The rotating disk 22 is turned and driven by a rotary driving device (not illustrated). The rotary driving device is, for example, an electric motor, but is not limited to this. In addition, an encoder (not illustrated) is connected to a drive shaft of a drive motor, and thus, it is possible to detect the phase position of the rotating disk 22.

On the conveyance surface 22a of the upper surface of the rotating disk 22, a workpiece feeding area 24, a sensing area 26, a pickup area 28, and a workpiece recovering area 30 are provided, aligned in a circumferential direction. The workpiece feeding area 24 is an area where the workpiece W is fed from the workpiece discharging section 18b.

The sensing area 26 is located at the downstream side of the workpiece feeding area 24 in the flow direction of the workpiece. At the sensing area 26, the position and posture of the workpiece W are detected by the workpiece detector 14.

The pickup area 28 is located at the downstream side of the sensing area 26 in the flow direction of the workpiece. At the pickup area 28, the robot 4 and the hand 6 pick up the workpiece W.

The workpiece recovering area 30 is located at the downstream side of the pickup area 28 in the flow direction of the workpiece. At the workpiece recovering area 30, the workpiece W, that is not picked up at the pickup area 28, is returned to the bowl 18. In detail, the workpiece W is returned from the conveyance carrier 8 to the bowl 18 via a workpiece recovering portion 32 located at the workpiece recovering area 30. As described above, in this embodiment, the workpiece recovering portion 32 is an opening that penetrates the standing wall 20.

A posture stabilizer 34 is provided on the conveyance surface 22a of the conveyance carrier 8. The posture stabilizer 34 suppresses changes in the position and posture of the workpiece W while the workpiece W is conveyed on the conveyance carrier 8. Specifically, the posture stabilizer 34 suppresses a change in the posture of the workpiece W between the sensing area 26 and the pickup area 28. In this embodiment, the posture stabilizer 34 is provided over the entire periphery of the conveyance surface 22a.

In this embodiment, the posture stabilizer 34 is a groove that is formed on the conveyance surface 22a and extends in the circumferential direction of the conveyance carrier 8. However, the posture stabilizer 34 is not limited to a groove. For example, the posture stabilizer 34 may be configured to change a friction coefficient with the conveyance surface 22a of the rotating disk 22 and may be made of different material from the rotating disk 22. Specifically, as the posture stabilizer 34, for example, a fibrous felt or an elastic body such as rubber may be attached to the conveyance surface 22a of the metallic rotating disk 22.

As shown in FIG. 4, the groove 34 suppresses rolling of the workpiece W when the rotating disk 22 rotates, and thus, the position and posture of the workpiece W can be stabilized. Especially, the groove 34 makes it possible to control the posture of the unstable cylindrical workpiece W such as a bolt to have a fixed posture.

In this embodiment, a wall surface 34a on a radial inner side of the groove 34 is inclined upward toward the radial inner side. On the other hand, a wall surface 34b on a radial outer side of the

groove 34 extends to the substantially vertical direction. In other words, an angle θo of the wall surface 34b on the radial outer side relative to a bottom wall 34c of the groove 34 extending in the horizontal direction is about 90°, and an angle θi of the wall surface 34a on the radial inner side relative to the bottom wall 34c is larger than 90°. The angle θi of the wall surface 34a on the radial inner side relative to the bottom wall 34c preferably falls within the range of from 90° to 150°, more preferably from 135° to 150°. However, the angle θi is not limited to this.

Since the wall surface 34b on the outer diameter side extends to the vertical direction, it is possible to prevent the workpiece from moving outward in the radial direction due to centrifugal force generated when the rotating disk 22 rotates. In addition, since the wall surface 34a on the inner diameter side is inclined, the workpieces W that are not picked up can be easily returned to the bowl 18 on the radial inner side.

### Robot

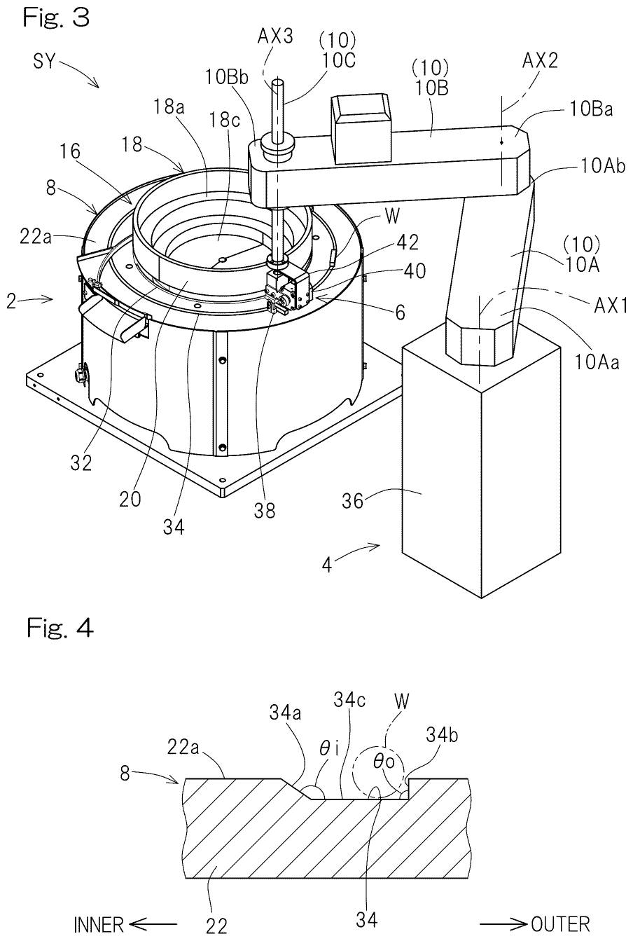

The robot 4 shown in FIG. 1 is a horizontal articulated robot having a plurality of arms 10, each of which moves in the horizontal direction. The robot 4 is turned between the first area A1 where the conveyance carrier 8 is located and the second area A2 for the next process. As shown in FIG. 3, the robot 4 of this embodiment has: a base 36 fixed to the floor surface; and three arms 10A, 10B, 10C, the first arm to the third arm.

The first arm 10A is in a square bar shape extending in the horizontal direction, a base end 10Aa of which is connected to the upper surface of the base 36 so as to be turned freely about a first rotational shaft AX1 in the vertical direction. The second arm 10B is in a square bar shape extending in the horizontal direction, a base end 10Ba of which is connected to a tip end 10Ab of the first arm 10A so as to be turned freely about a second rotational shaft AX2 in the vertical direction.

The third arm 10C is a cylindrical shaft member extending in the vertical direction and inserted into a tip end 10Bb of the second arm 10B. The third arm 10C is movable with respect to the tip end 10Bb of the second arm 10B in the vertical direction and rotatable about a third rotational axis AX3 in the vertical direction. The hand 6 is attached to a lower end 10Ca of the third arm 10C.

Each of the arms 10A, 10B, 10C is driven by an actuator (n illustrated). For example, the actuator is an electric motor, but is not limited to this. In this embodiment, the robot 4 is fixed to the floor surface, but may not be fixed. In addition, the structure of the robot 4 is not limited to the structure of this embodiment, but any working robot can be applied.

### Hand

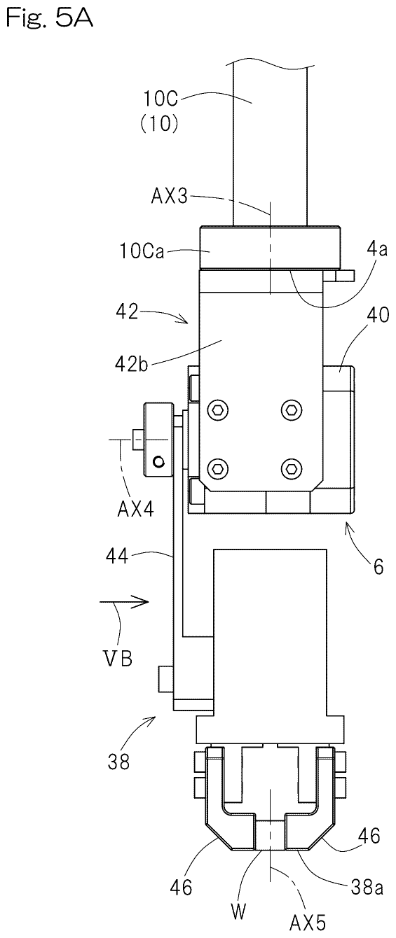

The hand 6 picks up the workpiece W on the conveyance carrier 8 in the first area A1 (FIG. 1) and places the workpiece W in the second are A2 (FIG. 1). FIG. 5A is an enlarged front view of the hand 6, and FIG. 5B is a side view of the hand 6 of FIG. 5A. As shown in FIG. 5B, the hand 6 includes: a claw 46 that grips or releases the workpiece W; a gripping portion 38 which moves the claw 46; and an actuator 40 with one or more degree of freedom that changes the posture of the gripping portion 38. In this embodiment, for example, the actuator 40 uses fluid such as compressed air.

The hand 6 is attached to the lower end 10Ca of the third 10C so as to be turned freely about the third rotational axis AX3. The third arm 10C of the robot 4 and the hand 6 are connected by an L-shaped bracket 42. Specifically, the lower end 10Ca of the third arm 10C is connected to an upper surface of a horizontal portion 42a of the bracket 42, and the actuator 40 of the hand 6 is connected to a vertical portion 42b of the bracket 42 by a bolt. In this embodiment, the hand 6 is attached to the inner surface of the vertical portion 42b of the bracket 42, i.e., the surface on the third rotational axis AX3 side. However, the shape of the bracket 42 and the arrangement of the hand 6 are not limited to this.

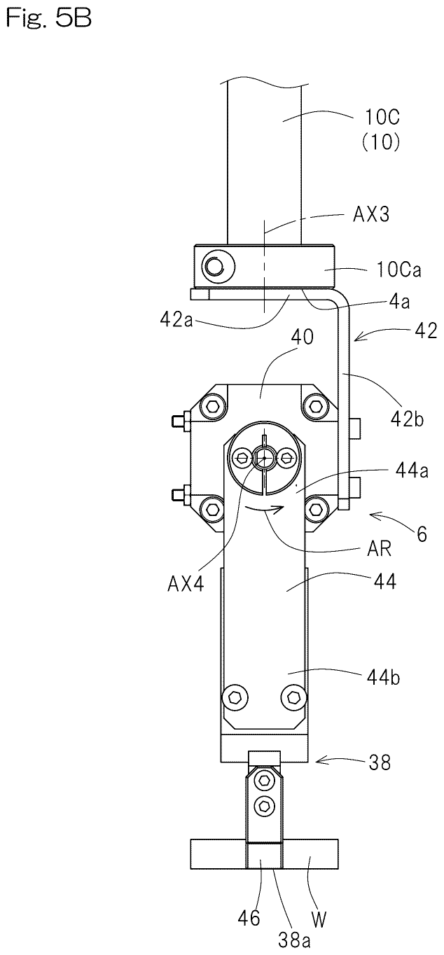

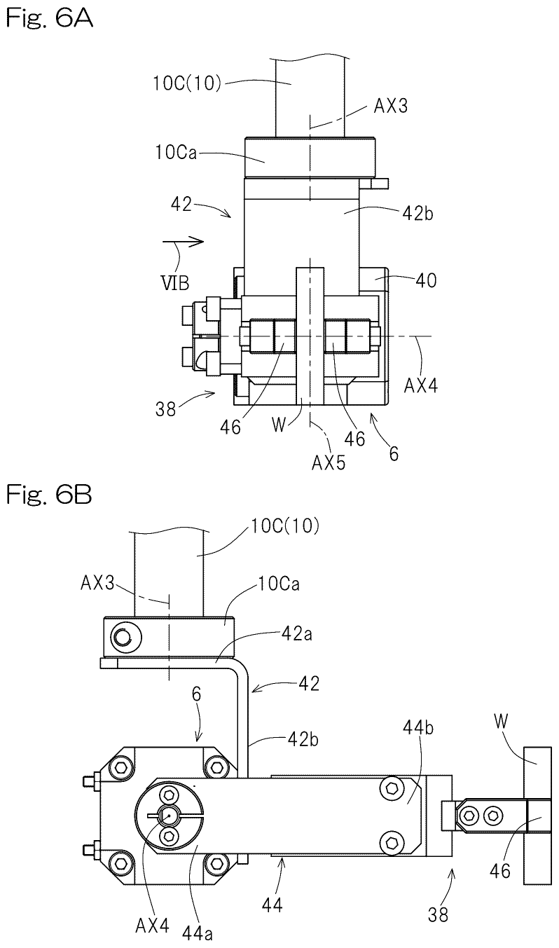

The actuator 40 has a fourth rotational axis AX4 extending the horizontal direction. The gripping portion 38 is connected to the actuator 40 via a connecting member 44. The connecting member 44 is made of a plate-shaped long member, a base end 44a of which is connected to the actuator 40 so as to be rotated freely about the fourth rotational axis AX4, and the gripping portion 38 is connected to a tip end 44b of the connecting member 44 by a bolt. When the actuator 40 is rotated by 90° in the direction of the arrow AR of FIG. 5B, the gripping portion 38 is located at the position shown in FIG. 6B. In this example, the fourth rotational axis AX4 intersects the third rotational axis AX3, and the gripping portion 38 is arranged in the circumferential direction of the fourth rotational axis AX4 with respect to the actuator 40.

FIG. 6A is a front view, and FIG. 6B is a side view when t actuator 40 is rotated by 90° in the direction of the arrow AR (FIG. 5B). FIGS. 5A and 5B illustrates the hand 6 facing downward. On the other hand, FIGS. 6A and 6B illustrates the hand 6 facing sideways. By rotating the bracket 42 about the third rotational axis AX3, the gripping portion 38 is moved to any position, and by rotating the connecting member 44 about the fourth rotational axis AX4, the posture of the gripping portion 38 is changed to any posture.

The hand 6 of the first embodiment of FIGS. 5A and 5B is a chuck device having a plurality of the claws 46 that can be opened and closed. In this embodiment, the hand 6 has two claws 46, but may have three or more claws 46. Details of the claw 46 will be described below. The hand 6 may be a suction pad. In this embodiment, the third rotational axis AX3 of the third arm 10C of the robot 4 corresponds to a fifth axis AX5 of the gripping portion 38, and the fifth axis AX5 is a gripping center of the gripping portion 38. However, the third rotational axis AX3 may not correspond to the fifth axis AX5. In other words, the fifth axis AX5 may be offset in the horizontal direction with respect to the third rotational axis AX3.

### Operation

The operation of the component supply system SY including the parts feeder 2 will be described. The workpiece W put into the bowl 18 shown in FIG. 1 is aligned and conveyed on the spiral conveying path 18a to the workpiece discharging section 18b located at the uppermost position of the bowl 18 by vibration. The workpiece W aligned is fed from the workpiece discharging section 18b to the workpiece feeding area 24.

The workpiece detector 14 detects the position and posture o the workpiece W fed to the workpiece feeding area 24 in the sensing area 26 located at the downstream side of the workpiece feeding area 24. Specifically, the controller 12 determines whether or not the workpiece W can be picked up based on a signal from the workpiece detector 14. Further, when the workpiece W can be picked up, the controller 12 determines where the hand 6 should be set and what posture the hand 6 should have.

In the pickup area 28 located at the downstream side of the sensing area 26, the position of the hand 6 is set by moving the arm 10 of the robot 4 and the posture of the hand 6 is set by driving the actuator 40 from the determination result of the controller 12 based on the signal from the workpiece detector 14. The hand 6 picks up the workpiece W at the set position and posture.

At this time, if the position and posture of the workpiece W detected in the sensing area 26 differ from the actual position and posture of the workpiece W in the pickup area 28, there is a risk that the hand 6 cannot pick up the workpiece W. In this embodiment, since the posture stabilizer 34 that is a groove suppresses changes in the position and posture of the workpiece W while the workpiece W is conveyed, the hand 6 can stably pick up the workpiece W.

After the workpiece W is picked up, the arm 10 of the robot 4 is moved to move the hand 6 to the second area A2, the actuator 40 is driven to set the posture of the hand 6, and then the hand 6 releases the workpiece W.

The workpiece W that is not picked up at the pickup area 2 is returned to the bowl 18 from the workpiece recovering area 30 located at the downstream side of the pickup area 28. At this time, since the wall surface 34a on the radial inner side of the groove 34 is inclined upward toward the radial inner side, the workpieces W can be easily returned to the bowl 18 from the workpiece recovering area 30. The workpiece W returned to the bowl 18 is conveyed again on the conveying path 18a by vibration. Thereafter, this operation is repeated.

### Structure of Claw of Hand

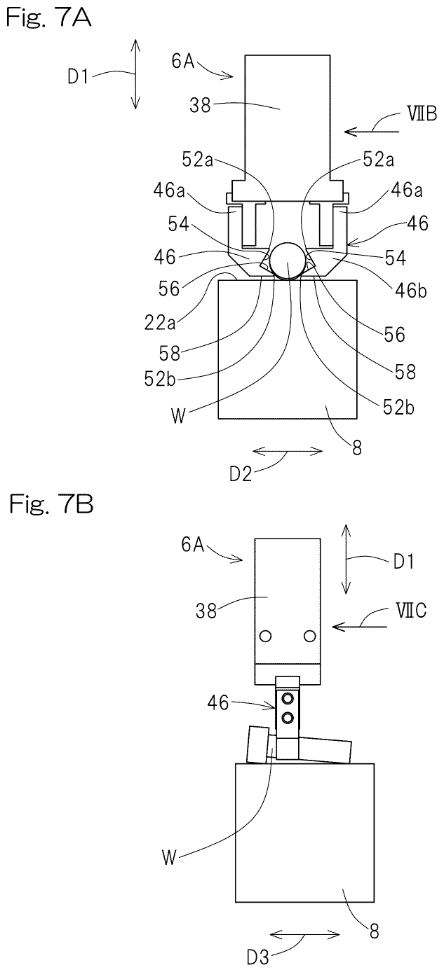

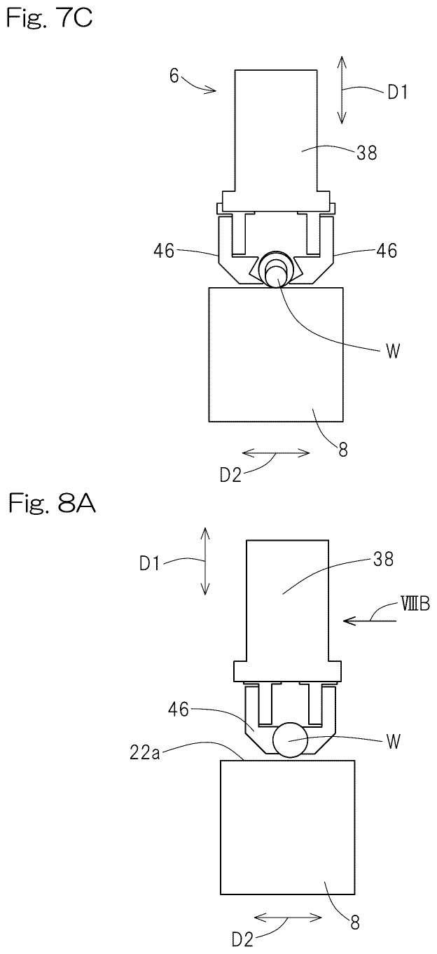

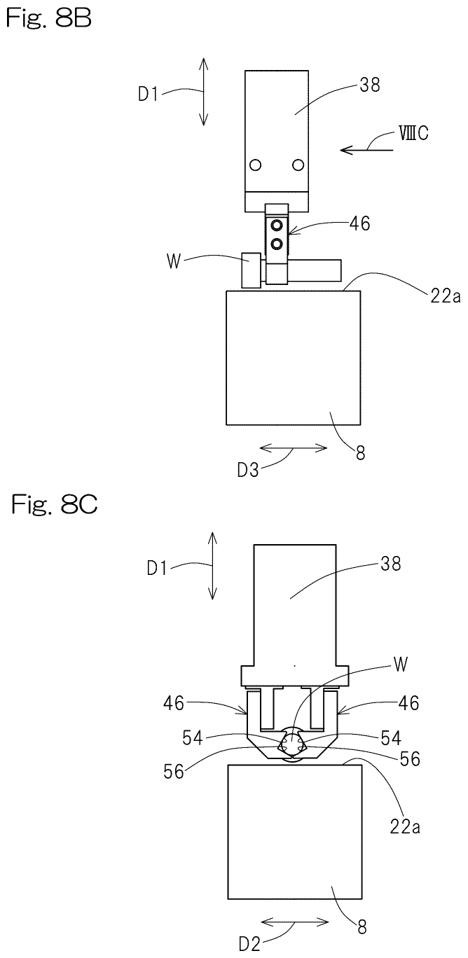

The structure of the claw 46 of the hand 6 of this embodiment is described by using FIGS. 7A-10B. FIGS. 7A-7C illustrate the hand 6 before picking up the bolt-shaped workpiece W. FIGS. 8A-8C illustrate the hand 6 in which the bolt-shaped workpiece W is picked up.

As shown in FIG. 7A, a pair of claws 46, 46 is provided on one end of the gripping portion 38 in a longitudinal direction D1. In this embodiment, the longitudinal direction corresponds to a vertical direction, and the pair of claws 46, 46 is provided on a lower end of the gripping portion 38. The gripping portion 38 is configured so that the pair of claws 46, 46 can be opened and closed in parallel or about any fulcrum. The claws 46 move in an open-close direction D2 (right-left direction in FIG. 7A), and grip or release the workpiece W.

In the following description, the direction in which the gripping portion 38 and the claws 46 extend is referred to as the “longitudinal direction D1”, and the direction in which the claws 46 are opened and closed is referred to as the “open-close direction D2”. In addition, the direction in which the workpiece W is gripped is referred to as a “gripping direction”, and the direction in which the workpiece W is released is referred as a “releasing direction”. In this example, a closing direction DR1 of the open-close direction D2 is the gripping direction, and an opening direction DR2 is the releasing direction. Moreover, the direction (right-left direction in FIG. 7B) which is orthogonal to both the longitudinal direction D1 and the open-close direction D2 is referred to as an “orthogonal direction D3”.

The claw 46 is supported at its base end 46a by the gripping portion 38 so as to be movable in the open-close direction D2. The claws 46 extends in a longitudinal direction, downward in the illustrated example, from the gripping portion 38, and has a gripping surface 52 gripping the workpiece W at its tip end 46b.

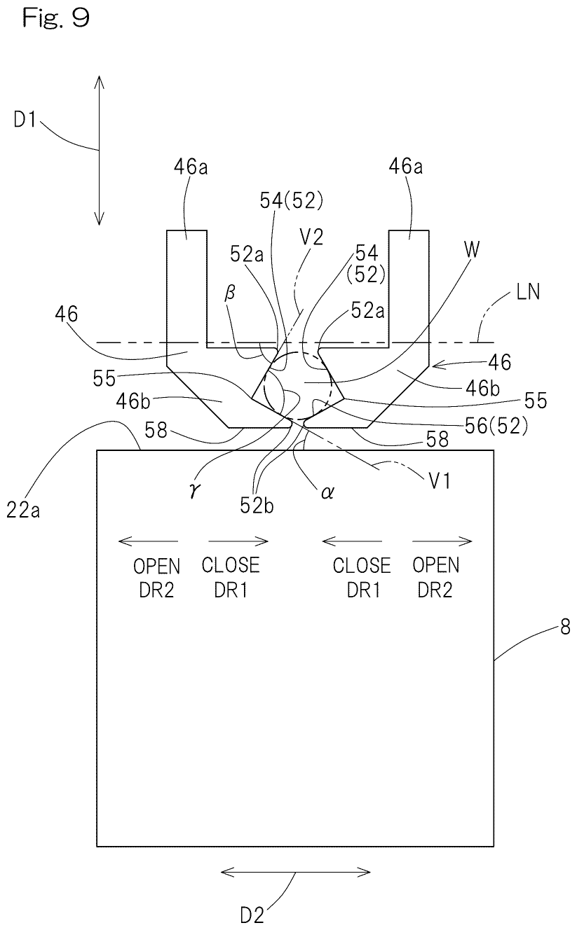

In detail, as shown in FIG. 9, the gripping surface 52 has: a first inclined surface 54 which extends in an inclined condition in the opening direction from its base end 52a (upper side in FIG. 9) in the longitudinal direction D1 toward a tip end side (lower side in FIG. 9) in the longitudinal direction D1; and a second inclined surface 56 which extends in an inclined condition in the opening direction from a tip end 52b (lower side in FIG. 9) in the longitudinal direction D1 toward a base end side (upper side in FIG. 9) in the longitudinal direction D1. A tip end of the first inclined surface 54 and a base end of the second inclined surface 56 are connected at a connecting portion 55.

In other words, as shown in FIG. 9, seen in the orthogonal direction D3, an end edge (end edge in the orthogonal direction) of the gripping surface 52 is formed in a V-shape recessed in the opening direction. The four surfaces 54, 54, 56, 56 of the pair of claws 46, 46 form a tangent plane that comes into contact with the cylindrical workpiece W to be gripped. In the following description, the base end 52a may be referred to as a “base end corner 52a”, and the tip end 52b may be referred to as a “tip end corner 52b”.

Seen in the orthogonal direction D3, an angle between a tip side virtual line V1 drawn by extending the second inclined surface 56 to the tip side (lower side of FIG. 9) and the horizontal conveyance surface 22a of the conveyance carrier 8 is defined as a tip end side angle α. In addition, an angle between a base end side virtual line V2 drawn by extending the first inclined surface 54 to the base end side (upper side of FIG. 9) and a parallel line LN parallel to the conveyance surface 22a is defined as a base end side angle β. Moreover, an angle between the first inclined surface 54 and the second inclined surface 56 is defined as an inclination angle γ. In this embodiment, the tip end side angle α is set to be smaller than the base end side angle β, i.e., α<β.

Furthermore, in this embodiment, the tip end side angle α is set to be 25° or more and 30° or less (25°≤α≤30°). On the other hand, the base end side angle β may be greater than 50° and smaller than 60° (50°<β<60°).

The base end 52a and the tip end 52b of the claw 46, i.e., base end corner 52a and the tip end corner 52b of the claw 46 are rounded. In other words, the base end corner 52a and the tip end corner 52b of the claw 46 have an R-shape. This can prevent the corners 52a, 52b of the claw 46 from damaging the workpiece W. In this embodiment, both the base end corner 52a and the tip end corner 52b have an R-shape. However, only the tip end corner 52b may have an R-shape.

Further, a surface 58 that forms the tip end corner 52b and does not come into contact with the workpiece W (the lower surface 58 of the claw 46 in FIG. 9) is configured to be parallel to the conveyance surface 22a when the longitudinal direction D1 of the gripping portion 38 is orthogonal to the horizontal conveyance surface 22a of the conveyance carrier 8. Alternatively, the lower surface 58 of the claw 46 may be inclined so that the tip end corner 52b is a lower end with respect to the conveyance surface 22a. This can prevent interference between the lower surface 58 of the claw 46 and the conveyance carrier 8.

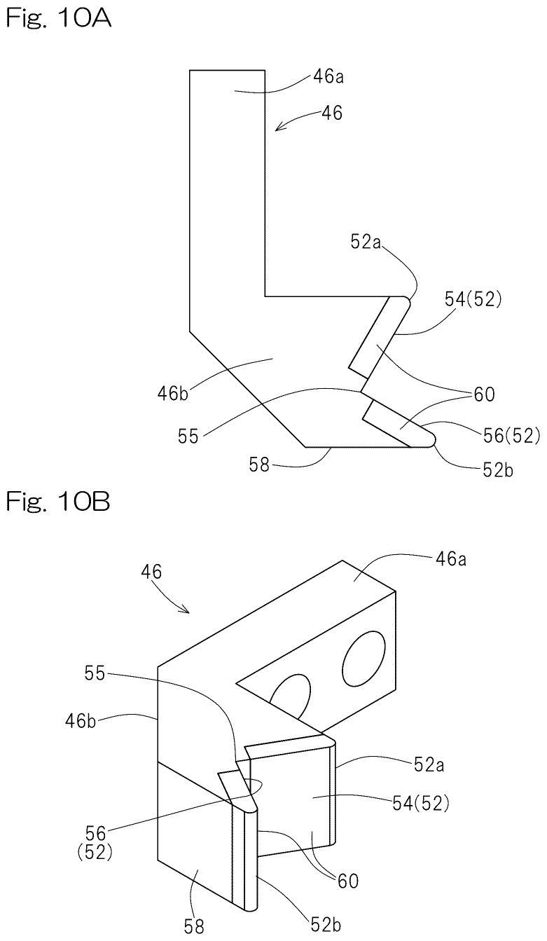

FIGS. 10A and 10B show a variation of the claw 46 of this embodiment. In the example of FIGS. 10A and 10B, sliding members 60 are attached to the first inclined surface 54 and the second inclined surface 56 of the claw 46. The sliding member 60 is made of a material having high sliding property, hardness of which is lower than the workpiece W. In this embodiment, a friction coefficient of the surface of the sliding member 60 is set to 0.2 or less to achieve high sliding property. The sliding member 60 is made of a material such as polyoxymethylene (POM) or monomer-cast nylon (MC nylon). However, the material of the sliding member 60 is not limited these.

Providing the sliding member 60 can prevent the workpiece from being damaged. In addition, setting the friction coefficient to 0.2 or less makes it easier for the workpiece W to move along the inclined surfaces 54,56 and enables to grip the cylindrical workpieces W inclined slightly to the conveyance carrier 8 at the stable position where the four inclined surfaces 54, 56 form a tangent plane.

In the example of FIGS. 10A and 10B, the sliding members 60 are attached to both the first and second inclined surfaces 54, 56. However, the sliding member 60 may be attached to only one of the first and second inclined surface 54, 56. In this case, the sliding member 60 may be attached to only the second inclined surface 56 on the tip end side that is more likely to damage the workpiece. The sliding member 60 may also be detachably attached to the inclined surfaces 54, 56. As an example, an engagement groove is provided on the inclined surfaces 54, 56, and the sliding member 60 is detachably attached to the engagement groove. However, the method for attaching the sliding member 60 is not limited to this. By making only the standing member 60 replaceable, the cost can be less expensive than replacing the whole claw 46, i.e., maintenance costs can be reduced.

In this embodiment, the friction coefficient of the surface of the sliding member 60 is set to 0.2 or less to achieve high sliding property. However, for example, the friction coefficient of the surface of the sliding member 60 may also set to be lower than that of surfaces other than the inclined surfaces 54, 56 of the claw 46. Alternatively, instead of attaching the sliding member 60, the friction coefficient may be reduced by applying a surface treatment such as coating or polishing to each inclined surface 54, 56.

In the component supply system SY of this embodiment, by changing a model number of a product on the production line, there are cases where the workpiece W having a different shape from those put into before the change is put into, or where the workpieces having different shapes are put into simultaneously. When the workpieces have different shape, these are often similar shapes. For example, bolts or pins having the same screw diameter but different lengths are put into by a set-up change or put into simultaneously.

Since the outer diameter of a head part of the bolt is larger than that of a shaft part, the bolt is placed at an angle inclined slightly with respect to the horizontal conveyance surface 22a. However, in the actuator 40 using compressed air, an operating angle cannot be adjusted automatically, and adjusting the opening angle manually takes time. While the operating angle can be adjusted by using an electric actuator, this increases costs and complicates control. Therefore, it is desirable to pick up the workpiece W inclined with respect to the conveyance surface 22a and the workpiece W that is horizontal with the conveyance surface 22a without changing the operating angle of the actuator 40.

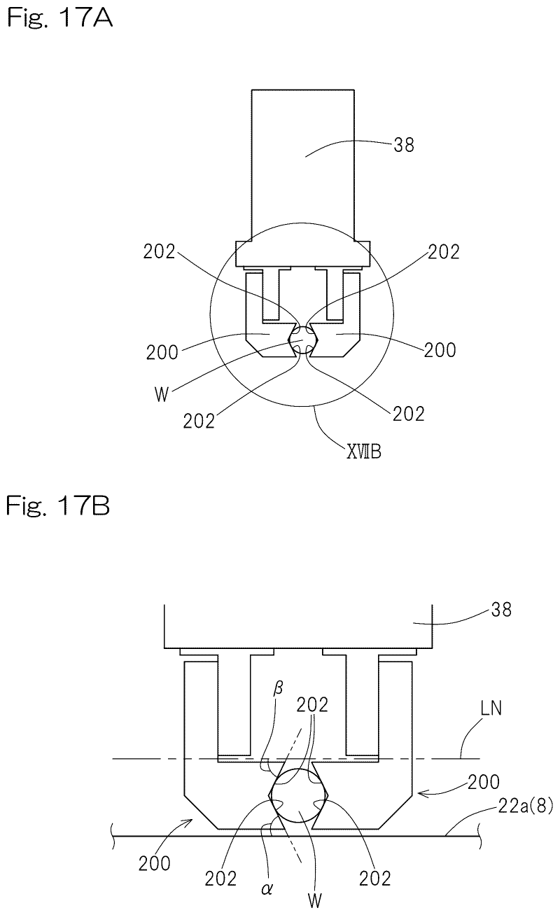

In contrast, when the cylindrical workpiece W is picked up from the radial direction, for example, as shown in the reference example of FIGS. 17A and 17B, a pair of claws 200 having inclined surfaces 202 whose tip end side angles α and base end side angles β are equal may be used to bring the cylindrical workpiece W into contact with the four inclined surfaces 202 and pick it up.

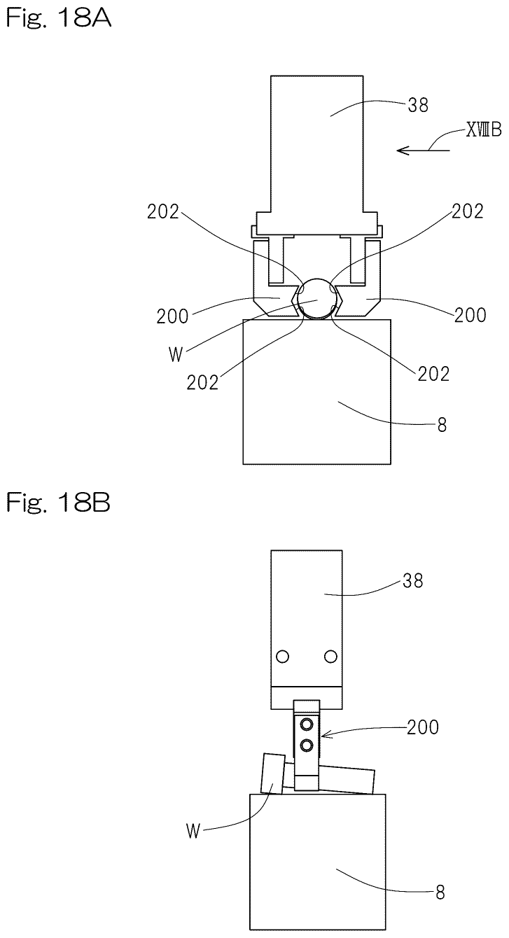

However, for example, as shown in FIGS. 18A and 18B, when the angle at which the workpiece W is picked up is fixed in a direction orthogonal to the conveyance surface 22a (a vertical direction in FIG. 18A), it is difficult for the workpiece W inclined slightly such as a bolt to copy the four inclined surfaces 102 of the claws, which makes the posture of the workpiece W after picked up unstable. Therefore, when the workpiece W picked up is placed in the second area A2 (FIG. 1), a positional error of the workpiece W becomes large.

In this way, in the claws 200 having the four inclined surfaces 202 whose tip end side angles α and base end side angles β are equal as shown in the reference example of FIGS. 17A-18B, it is not possible to stably pick up all of the cylindrical workpiece W slightly inclined with respect to the conveyance carrier 8, the cylindrical workpiece W placed horizontally and the cylindrical workpieces W having different diameters.

It is also possible to consider making the workpiece W copy the inclined surface 202 by increasing gripping force of the gripping portion 38. However, this increases the size and weight of the gripping portion 38, increases an interference area with the workpiece W and the parts feeder 2, and reduces workpiece load capacity of the robot 4 (FIG. 1). Moreover, it is necessary to increase rigidity of the claw 200 in accordance with gripping force of the gripping portion 38, which makes the claw 200 expensive.

In contrast, as shown in FIGS. 7A, 7B and 7C, when the hand 6 of this embodiment picks up the bolt-shaped workpiece W placed in an inclined state with respect to the conveyance surface 22a from above in the radial direction, the hand 6 picks up the workpiece W by scooping it up with the tip end corner 52b of the claw 46. At this time, since the tip end side angle α is small, the workpiece W inclined to the conveyance surface 22a can be easily picked up.

In addition, since the base end side angle β is set appropriately, as shown in FIG. 8C, the cylindrical workpiece W can easily copy the four inclined surfaces 54, 56. As a result, as shown in FIG. 8B, it is possible to pick up the workpiece W in a horizontally stable posture.

### Effects and Advantages

According to the above configuration, the posture stabilizer 34 shown in FIG. 1 suppresses changes in the position and posture of the workpiece W while the workpiece W is conveyed on the conveyance carrier 8. This makes stable the pick-up operation of the workpiece W by the robot 4. As a result, it is possible to improve work efficiency.

In particular, the position and posture of the workpiece W are detected in the sensing area 26, and the workpiece W having the detected position and posture is picked up in the pickup area 28. At this time, if the position and posture of the workpiece W detected in the sensing area 26 differ from the position and posture of the workpiece W in the pickup area 28, the workpiece W cannot be picked up, which deteriorates work efficiency. In the above configuration, since the posture stabilizer 34 suppresses changes in the position and posture of the workpiece W, the position and posture of the workpiece W do not change between the sensing area 26 and the pickup area 28. Therefore, the workpiece W is picked up stably, which improves work efficiency.

Since the since the posture stabilizer 34 is a groove formed the conveyance surface 22a, the configuration of the posture stabilizer 34 is simple and easy to achieve. Since the wall surface 34a on the radial inner side of the groove 34 is inclined upward toward the radial inner side, the workpieces W that are not picked up can be easily returned to the bowl 18 from the workpiece recovering area 30.

In addition, since the position and posture of the gripping portion 38 of the hand 6 is changeable, it is possible to prevent the hand 6 from coming into contact with other workpieces W or equipment when the workpiece W on the conveyance carrier 8 is picked up. As a result, it is possible to prevent malfunction of the hand 6 or other equipment and also to improve work efficiency.

In this way, in the above embodiment, the gripping portion of the hand 6 can approach the workpiece W at various angles, i.e., in an optimal position and posture. For example, the workpiece W may be picked up in a state where the hand 6 faces downward as shown in FIGS. 5A and 5B, and may be placed in a state where the hand 6 faces sideways as shown in FIGS. 6A and 6B by changing the posture. On the other hand, the workpiece W may be picked up in a state where the hand 6 faces sideways as shown in FIGS. 6A and 6B, and may be placed in a state where the hand 6 faces downward as shown in FIGS. 5A and 5B by changing the posture. Alternatively, the workpiece W may be picked up and placed in a state where the posture of the hand 6 is the same in both processes, i.e., the hand 6 faces downward or sideways in both processes. In this way, since the posture can be changed freely, it is possible to prevent the hand 6 from interfering with peripheral equipment or other workpieces.

In the parts feeder 2 having the disk-shaped conveyance carrier 8, it is possible to achieve saving space compared to a liner conveyance carrier, but the hand 6 is more likely to come into contact with parts of the parts feeder 2. According to this configuration, since the position and posture of the gripping portion 38 of the hand 6 is changeable, it is possible to prevent the hand 6 from coming into contact with parts of the parts feeder 2.

In the above embodiment, since the parts feeder 2 includes the standing wall 20 protruding above the conveyance carrier 8 between the vibrating bowl feeder 16 and the conveyance carrier 8, there is concern that the hand 6 comes into contact with the standing wall 20. According to the above configuration, since the position and posture of the gripping portion 38 of the hand 6 is changeable, it is possible to prevent the hand 6 from coming into contact with the standing wall 20 of the parts feeder 2 when the workpiece W on the conveyance carrier 8 is picked up.

As shown in FIG. 9, reducing the tip end side angle α makes it easier to scoop up the workpiece W inclined slightly to the conveyance carrier 8. In addition, increasing the base end side angle β makes larger the inclination angle γ between the first inclined surface 54 and the second inclined surface 56. Accordingly, a tangent line between the four inclined surfaces 54, 56 of the claws 46 and the cylindrical workpiece W becomes closer to the connecting portion 55 where the first inclined surface 54 and the second inclined surface 56 are connected. Thus, even when the diameter of the cylindrical workpiece W increases, it is possible to pick up the workpiece W so that the four inclined surfaces 54, 56 form a tangent plane. Therefore, it is also possible to stably pick up the cylindrical workpieces W having different diameters. Accordingly, in addition to the cylindrical workpiece W placed horizontally to the conveyance carrier 8, it is also possible to stably pick up the cylindrical workpiece W inclined slightly to the conveyance carrier 8 and the cylindrical workpieces W having different diameters.

In this embodiment, the tip end side angle α is set to be 25° or more and 30° or less, and the base end side angle β is greater than 50° and smaller than 60°, i.e., 25°≤α≤30° and 50°<β<60°. When the tip end side angle α is smaller than 25°, the tip end corner 52b becomes thinner, which reduces rigidity of the tip end of the claw 46. In addition, when the tip end side angle α is greater than 30°, it is difficult to scoop up the workpiece W inclined slightly to the conveyance carrier 8. The base end side angle β is set so that the inclination angle γ is adjusted to an outer diameter of the cylindrical workpiece W. The simulation has confirmed that setting the base end side angle β to be greater than 50° and smaller than 60° makes it possible to stably pick up a cylindrical workpiece having a desired outer diameter. In other words, setting the base end side angle β to 50°<β<60°makes it possible to stably pick up cylindrical workpieces having various outer diameters.

In this embodiment, the base end corner 52a and the tip end corner 52b of the claw 46 have an R-shape. This configuration can prevent the corners 52a, 52b of the claw 46 from damaging the workpiece W. Incidentally, only the tip end corner 52b that is more likely to come into contact with the workpiece W may have an R-shape.

In this embodiment, the lower surface 58 extends parallel to the conveyance surface 22a of the conveyance carrier 8. According to this configuration, interference between the claw 46 and the conveyance carrier 8 can be prevented. Alternatively, the lower surface 58 of the claw 46 may be inclined so that the tip end corner 52b of the claw 46 is at the lowest position during picking up the workpiece W. This can also prevent interference between the claw 46 and the conveyance carrier 8.

In this embodiment, as shown in FIGS. 10A and 10B, the sliding members 60 may be attached to the inclined surfaces 54, 56 of the claw 46. According to this configuration, it is possible to prevent the workpiece W from being damaged when picked up by contact with the claw 46. In this case, the sliding member 60 may be detachably attached to the inclined surfaces 54, 56 of the claw 46. This makes it possible to replace only the sliding member 60 instead of the whole claw 46, which facilitates maintenance and reduce maintenance and management costs.

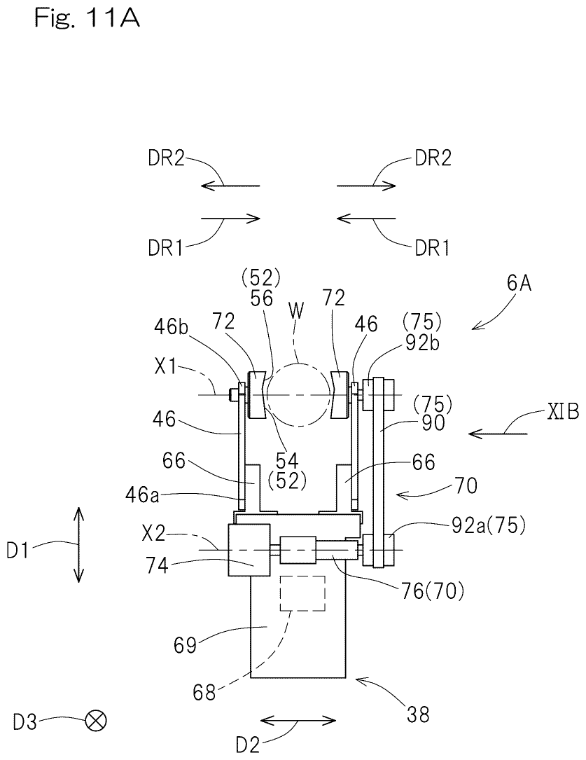

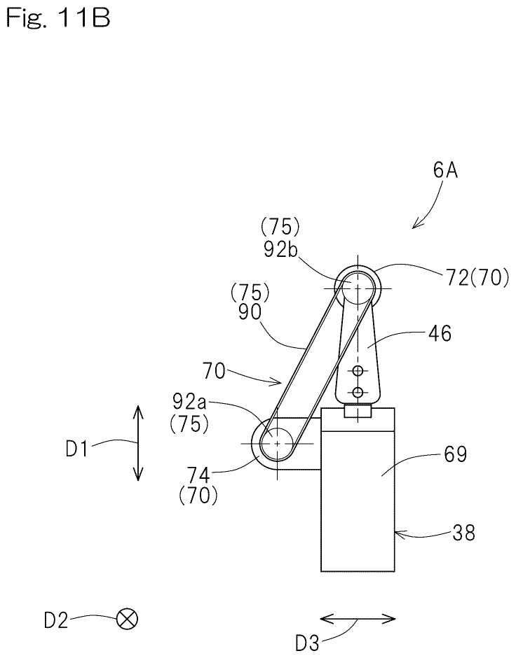

The structure of the claw 46 of the hand 6A of the second embodiment is described by using FIGS. 11A-13C. In the following description, the common reference numerals are used for the same features as in the first embodiment, and the detailed description is omitted. As shown in FIG. 11A, the hand 6A includes: a plurality of the claws 46 that grip or release the workpiece W; and the gripping portion 38 which moves the claw 46 in the gripping direction DR1 for gripping the workpiece and in the releasing direction DR2 for releasing the workpiece.

The gripping portion 38 includes: a gripping mechanism 66 moving in the gripping direction DR1 and the releasing direction DR2 to which the claw 46 is attached; and a first driving source 68 which moves the gripping mechanism 66 in the gripping direction DR1 and the releasing direction DR2. Specifically, the gripping portion 38 has a box-shaped gripping portion main body 69, and the fist driving source 68 is housed inside the gripping portion main body 69.

The gripping mechanism 66 is provided to protrude from the gripping portion main body 69 and moves relatively to the gripping portion main body 69 in the gripping direction DR1 and the releasing direction DR2 by the power of the first driving source 68. In this embodiment, two gripping mechanisms 66 are provided. The number of the gripping mechanism 66 is not limited to this, and may be, for example, three or more.

As in the first embodiment, in this embodiment, the claws 46 grip the workpiece W by closing the gripping mechanism 66 (by moving it in the closing direction). In other words, in this embodiment, the gripping direction DR1 for gripping the workpiece W is the closing direction and the releasing direction DR2 for releasing the workpiece W is the opening direction.

The first driving source 68 is, for example, an air cylinder driven by compressed air. However, the first driving source 68 is not limited to this, and may be a hydraulic actuator or an electric motor. In this embodiment, one first driving source 68 drives two gripping mechanisms 66. However, the first driving source 68 may be provided for each gripping mechanism 66.

The hand 6 further includes a rotation transmission mechanism 70 that rotates the workpiece W. The rotation transmission mechanism 70 rotates the workpiece W about a rotational axis X1 parallel to the open-close direction. The rotation transmission mechanism 70 includes: a rotational portion 72 that is rotatable relative to the claw 46 about the rotational axis X1; and a second driving source 74 for rotatably driving the rotational portion 72 about the rotational axis X1.

The rotation transmission mechanism 70 further includes: a power transmission mechanism 75 that transmits the power of the second driving source 74 to the rotational portion 72; and a telescopic rotational mechanism 76 that transmits rotation of the second driving source 74 to the power transmission mechanism 75. In other words, rotation of the second driving source 74 is transmitted to the rotational portion 72 via the telescopic rotational mechanism 76 and the power transmission mechanism 75.

The second driving source 74 of this embodiment is a motor. The second driving source 74 is not limited to the motor. For example, it is possible to use a structure where rotation is mechanically caused by using a spring, a structure where pneumatic pressure is used such as air cylinder or a structure where hydraulic pressure is used such as a hydraulic actuator. When the motor is used as the second driving source 74, it is possible to easily change the posture of the workpiece W to have any desired inclination compared to pneumatic pressure or hydraulic pressure.

The first driving source 68 and the second driving source 74 may have different structures, i.e., the fist driving source 68 has a structure where pneumatic pressure is used and the second driving source 74 has a structure where electricity is used, or they may have the sane structure. Moreover, in this embodiment, the power of the second driving source 74 is supplied to only one of the two claws 46, but it may be supplied to both.

The second driving source 74 is fixed to the gripping portion main body 69 of the gripping portion 38, and does not move in the open-close direction with the gripping mechanism 66. In addition, since the second driving source 74 does not move in the open-close direction with the gripping mechanism 66 of the gripping portion 38, load in the open-close direction is reduced. Therefore, the gripping mechanism 66 can be operated at high speed. Further, since the objects to be rotated by the power of the second driving source 74 are only the workpiece W and the rotational portion 72, the moment of inertia is reduced, which enables high-speed rotation.

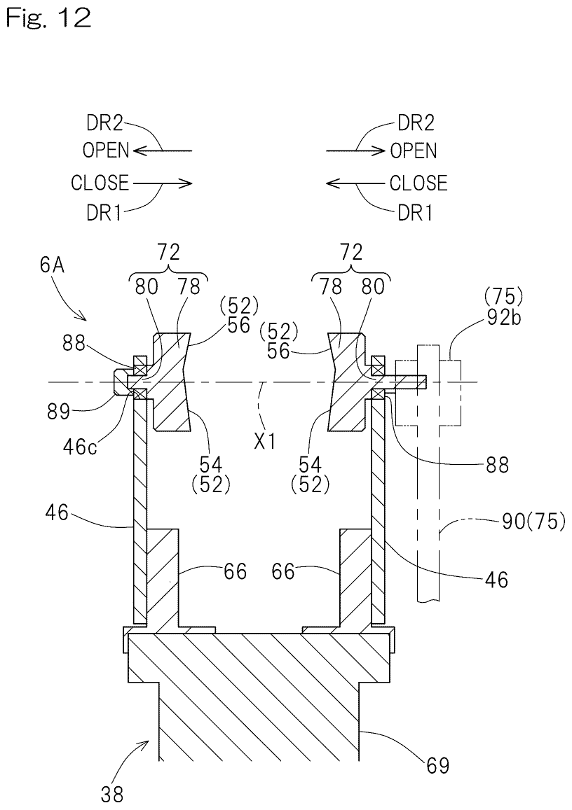

The rotational portion 72 is attached to each of the plurality of the claws 46, and moves in the open-close direction with the claw 46. In this embodiment, the rotational portion 72 is provided at the tip end of the claw 46. As shown in FIG. 12, the rotational portion 72 includes: a disk-shaped rotational portion main body 78; and a shaft body 80 extending in the opening direction from an end surface of the rotational portion main body 78. A central axis of the rotational portion main body 78 corresponds to a central axis of the shaft body 80. In addition, central axes of a pair of the rotational portions 72 of this embodiment correspond to each other.

The rotational portion 72 of this embodiment is made of metal. However, the material of the rotational portion 72 is not limited to this, and may be made of resin, for example. In addition, a rubber sheet or a rubber concavity and convexity may be provided on the griping surface 52 facing the closing direction of the rotational portion main body 78 of the rotational portion 72. This prevents the workpiece W from slipping when the workpiece W is gripped or the workpiece W gripped is rotated.

As shown in FIG. 12, a through hole 46c facing the open-close direction is provided at the tip end of the claw 46. In this embodiment, the shaft body 80 of the rotational portion 72 is inserted into the through hole 46c through a rolling bearing 88. This makes it possible to rotatably support the rotational portion 72 by the claw 46. An axis of the through hole 46c corresponds to the central axis of the rotational portion 72. In other words, the axis of the thorough hole 46c corresponds to the rotational axis X1 of the rotational portion 72. In this embodiment, the rolling bearing 88 is used, but a bearing other than a rolling bearing, for example, a sliding bearing may be used.

As shown in FIG. 11A, the power transmission mechanism 75 is connected to the tip end of the shaft body 80 of one of the rotational portions 72. The power transmission mechanism 75 is connected to the rotational portion 72, and moves in the gripping direction DR1 and the releasing direction DR2 with the rotational portion 72. A release preventing member 89 is attached to the tip end of the shaft body 80 of the other rotational portion 72 that is not connected to the second driving source 74. The release preventing member 89 is, for example, a nut. In this embodiment, the power transmission mechanism 75 is connected to one of the rotational portions 72. However, it is sufficient that the power transmission mechanism 75 is connected to at least one rotational portion 72, and the power transmission mechanism 75 may be connected to multiple rotational portions 72.

In this embodiment, a belt-shaped endless power transmission member 90, specifically a timing belt, is used as the power transmission mechanism 75. The endless power transmission member 90 may be a drive chain.

The timing belt 90 is provide between the telescopic rotational mechanism 76 and the rotational portion 72. A primary pulley 92a and a secondary pulley 92b are arranged on the surface facing outward in the open-close direction of the claw 46. The timing belt 90 is stretched over the primary pulley 92a and the secondary pulley 92b. The secondary pulley 92b is arranged coaxially with the rotational axis X1 of the rotational portion 72 and connected to the shaft body 80 of the rotational portion 72.

The primary pulley 92a is connected to the telescopic rotational mechanism 76. The telescopic rotational mechanism 76 is arranged between the second driving source 74 and the power transmission mechanism 75, and is telescopic in the gripping direction DR1 and the releasing direction DR2. In other words, the telescopic rotational mechanism 76 transmits rotation of the second driving source 74 to the power transmission mechanism 75, and moves in the gripping direction DR1 and the releasing direction DR2 with respect to the second driving source 74.

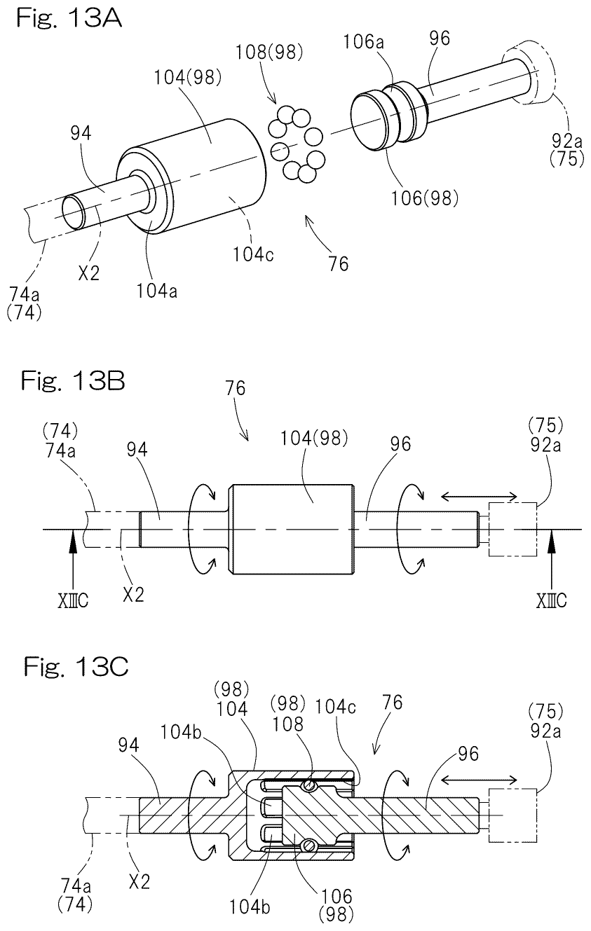

Specifically, as shown in FIG. 13A, the telescopic rotational mechanism 76 includes: a first rotational shaft 94 connected to an output shaft 74a of the second driving source 74; a second rotational shaft 96 connected to the primary pulley 92a of the power transmission mechanism 75; and a telescopic rotational structure 98 provided between the first rotational shaft 94 and the second rotational shaft 96. In other words, in this embodiment, the primary pulley 92a of the power transmission mechanism 75 constitutes an inlet rotating body of the power transmission mechanism 75 to which the second rotational shaft 96 is connected.

As shown in FIG. 13B, the telescopic rotational structure 98 transmits rotation of the first rotational shaft 94 to the second rotational shaft 96 and supports the second rotational shaft 96 movably in the gripping direction DR1 and the releasing direction DR2 relative to the first rotational shaft 94.

Specifically, as shown in FIG. 13A, the telescopic rotational structure 98 includes: a cylindrical outer member 104; an inner member 106 inserted into a hollow hole 104c of the outer member 104; and a rolling element 108 interposed between the outer member 104 and the inner member 106. In this embodiment, the rolling elements 108 includes eight balls arranged in the circumferential direction. However, the shape and number of the rolling element 108 are not limited to this.

In this embodiment, the outer member 104 has a bottomed cylindrical shape one end side (a left end side in FIG. 13C) of which is closed and the other end side of which is open, and a shaft end of the first rotational shaft 94 is connected to a bottom 104a on the one end side. In this embodiment, the first rotational shaft 94 and the outer member 104 are inseparably integrated. In other words, the outer member 104 is provided on the shaft end of the first rotational shaft 94. That is, one end of the first rotational shaft 94 is connected to the output shaft 74a of the second driving source 74, and the other end is connected to the outer member 104. Therefore, the outer member 104 is rotatable about the axis X2 of the output shaft 74a of the second driving source 74 with respect to the gripping portion 38 (FIG. 11A).

As shown in FIG. 13, a groove 104b extending in the axial direction is provided on an inner peripheral surface of the outer member 104. A plurality of the grooves 104b is arranged in the circumferential direction. In this embodiment, the number of the grooves 104b is the same as that of the rolling elements 108. i.e., eight.

As shown in 13A, in this embodiment, the inner member 106 has a columnar shape, and a shaft end of the second rotational shaft 96 is connected to one end surface (a right end surface in FIG. 13C) of the inner member 106. In this embodiment, the second rotational shaft 96 and the inner member 106 is inseparably integrated. In other words, the inner member 106 is provided on the shaft end of the second rotational shaft 96. A circumferential groove 106a extending in the circumferential direction is formed on an outer diameter surface of an axial intermediate portion of the inner member 106.

As shown in FIG. 13C, an outer diameter of the inner member 106 is set to be slightly smaller than an inner diameter of the outer member 104 and larger than an outer diameter of the second rotational shaft 96. The rolling element 108 is arranged between an inner diameter surface of the outer member 104 and an outer diameter surface of the inner member 106. Therefore, rotation of the outer member 104 is transmitted to the inner member 106 via the rolling element 108. In other words, the inner member 106 is rotatably connected to the outer member 104 via the rolling element 108.

Specifically, the rolling element 108 is arranged between the circumferential groove 106a of the inner member 106 and the groove 104b of the outer member 104. The rolling elements 108 are movable in the axial direction (the open-close direction) along each groove 104b of the outer member 104. Namely, the inner member 106 is rotatable about the axis X2 of the output shaft 74a of the second driving source 74 with respect to the gripping portion 38 (FIG. 11A) and movable in a direction parallel to the open-close direction.

The other end of the second rotational shaft 96 is connected to the power transmission mechanism 75 of the rotation transmission mechanism 70. Thus, one end of the second rotational shaft 96 is connected to the inner member 106, and the other end of second rotational shaft 96 is the connected to the inlet rotating body (primary pulley) 92a of the power transmission mechanism 75 of the rotation transmission mechanism 70

The first and second rotational shafts 94, 96, the outer member 104 and the inner member 106 may be made of metal or resin. In addition, lubricant such as grease may be sealed in a gap between the outer member 104 and the inner member 106. In this case, a seal member may be provided at an opening end of the outer member 104 to prevent grease from leaking outside.

By providing the telescopic rotational mechanism 76, as shown in FIG. 13C, the first rotational shaft 94 and the outer member 104 rotate about the axis X2 of the output shaft 74a of the second driving source 74, and the second rotational shaft 96 and the inner member 106 rotate via the rolling element 108. Further, the second rotational shaft 96 and the inner member 106 move in a direction parallel to the open-close direction of the gripping mechanism 66 in accordance with the opening and closing of the gripping mechanism 66 in FIG. 11A. This makes it possible to transmit rotational power to the rotational portion 72 at the tip end of the claw 46 even when the gripping mechanism 66 opens or closes.

In this embodiment, the outer member 104 is provided on the shaft end of the first rotational shaft 94, and the inner member 106 is provided on the shaft end of the second rotational shaft 96. However, the inner member 106 may be provided on the shaft end of the first rotational shaft 94, and the outer member 104 may be provided on the shaft end of the second rotational shaft 96.

In this embodiment, the rotation transmission mechanism 70 and the claws 46 are integrated to form a sub-assembly. Specifically, the rotational portion 72, the claws 46, the power transmission mechanism 75, the telescopic rotational mechanism 76 and the second driving source 74 are integrated. The integrated sub-assembly is attached to the gripping portion 38. This makes it possible to apply the claw 46 having the rotation transmission mechanism 70 of this embodiment to the existing gripping portion. In particular, since it is easily possible to adjust the size of the gripping mechanism 66 and the length of the claw 46, versatility is high.

In other words, in this embodiment, the rotation transmission mechanism 70 and the claws 46 constitute an integrated module. Specifically, the rotational portion 72, the claw 46, the timing belt 90, the pulleys 92a, 92b, the first and second rotational shafts 94, 96, the outer member 104, the inner member 106, the rolling element 108 and the second driving source 74 are modularized.

When the hand 6A picks up the workpiece W, by driving the first driving source 68, the gripping mechanism 66 and the claw 46 fixed to the gripping mechanism 66 move in the gripping direction DR1. At this time, the second driving source 74 fixed to the gripping portion main body 69, the first rotational shaft 94 of the telescopic rotational mechanism 76 connected to the second driving source 74, and the outer member 104 do not move in the gripping direction DR1.

On the other hand, in the telescopic rotational mechanism 76, the inner member 106 connected to the outer member 104 via the rolling element 108 to be movable in the open-close direction and the second rotational shaft 96 move in the gripping direction DR1. Moreover, the rotation transmission mechanism 70 connected to the second rotational shaft 96 and the rotational portion 72 connected to the rotation transmission mechanism 70 move in the gripping direction DR1.

When the second driving source 74 is driven in the state where the hand 6A grips the workpiece W, the first rotational shaft 94 and the outer member 104 in FIG. 13C rotate. When the outer member 104 rotates, the inner member 106 and the second rotational shaft 96 rotate via the rolling element 108.

When the second rotational shaft 96 rotates, the pulley 92a at the upstream side in FIG. 11A rotates. This rotation is transmitted to the pulley 92b at the downstream side via the timing belt 90, causing the pulley 92b at the downstream side to rotate. When the pulley 92b at the downstream side rotates, one of the rotational portions 72 connected to the pulley 92b rotates. This rotation is transmitted to the other rotational portion 72 via the workpiece W, causing the other rotational portion 72 to rotate. Therefore, the workpiece W rotates about the rotational axis X1. This makes it possible to change the posture of the workpiece W.

When the hand 6A releases the workpiece W, the first driving source 68 is driven to move the gripping mechanism 66 and the claw 46 fixed to the gripping mechanism 66 in the releasing direction DR2. At this time, as well as in gripping the workpiece W, the second driving source 74, the first rotational shaft 94 and the outer member 104 of the telescopic rotational mechanism 76 do not move in the releasing direction DR2, but the inner member 106 and the second rotational shaft 96 of the telescopic rotational mechanism 76 and the rotational portion 72 move in the releasing direction DR2.

### Structure of Gripping Surface

As shown in FIG. 11A, the claw 46 is supported at its base end 46a by the gripping portion 38 so as to be movable in the open-close direction D2. The claws 46 extends in the longitudinal direction D1, upward in the illustrated example, from the gripping portion 38, and has the gripping surface 52 gripping the workpiece W at its tip end 46b. In detail, the gripping surface of the rotational portion 72 constitutes the gripping surface 52 of the claw 46.

The structure, shape, the tip end side angle α and the base end side angle β of the gripping surface 52 of this embodiment are the same as those of the gripping surface 52 of the first embodiment described in FIG. 9. As shown in a variation of the first embodiment in FIGS. 10A and 10B, the sliding members 60 may be attached to the first inclined surface 54 and the second inclined surface 56 of the claw 46 of this embodiment. Moreover, the first inclined surface 54 and the second inclined surface 56 achieve the same functions and effects as those of the first embodiment described in comparison with the reference example shown in FIGS. 17A-18B.

### Effects and Advantages

According to the hand 6A of the second embodiment, the same effect as the hand 6 of the first embodiment is achieved. According to the hand 6A of the second embodiment, since the rotational portion 72 shown in FIG. 12 can rotate the workpiece W gripped by the claw 46 about the rotational axis X1 parallel to the open-close direction D2, it is possible to stably move and place the workpiece W regardless of its posture when picked up.

Further, in the hand 6 having two claws 46, it is generally necessary to change the size of the gripping portion 38 itself, opening and closing strokes, and the length of the claw 46 in accordance with the size of the workpiece W to be gripped.

According to the hand 6A of the second embodiment, as shown in FIG. 11A, the rotational portion 72 of the rotation transmission mechanism 70 is separately provided at the tip end of the claw 46 attached to the griping mechanism 66 of the gripping portion 38 and rotates the workpiece W about the rotational axis X1 parallel to the gripping direction DR1 and the releasing direction DR2 of the claw 46. The gripping mechanism 66 is moved by the power of the first driving source 68, and the rotational portion 72 is rotated by the power of the second driving source 74. In other words, the gripping mechanism 66 and the rotational portion 72 are provided independently. Accordingly, when the heights of the workpieces W to be gripped during set-up change are different, it is sufficient to replace the claw 46 and the rotation transmission mechanism 70 supported by the claw 46, i.e., there is no need to replace the gripping portion 38. As a result, the length from the root of the claw 46 to the rotational axis of the second driving source 74 can be easily changed.

Moreover, the second driving source 74 does not move with the gripping mechanism 66 of the gripping portion 38 in the open-close direction. Thus, since the load in the open-close direction is reduced, the gripping mechanism 66 can be operated at high speed. In addition, since only the rotational portion 72 is rotated rather than the entire gripping portion 38, the objects to be rotated are limited to the workpiece W and the rotational portion 72. This reduces the weight and the moment of inertia of the objects to be rotated. Consequently, it is possible to achieve high-speed rotation of the rotational portion 72 and low torque of the second driving source 74, which makes it possible to reduce the size and weight of the second driving source 74.

According to the above configuration, after gripping the workpiece W, it is possible to invert the front and the back of the workpiece W by the rotational portion 72 rotating the workpiece W without gripping it again. This can shorten conveyance time. In addition, since it is not necessary to provide a temporary table to change the posture of the workpiece W, it is possible to achieve saving space.

Moreover, since the workpiece W is rotated by the rotational portion 72 provided at the tip end of the claw 46 shown in FIG. 11A, the moment of inertia is smaller than the case where the entire claw 46 including the gripping mechanism 66 is rotated. Therefore, it is possible to rotate the workpiece W at a higher speed.

In this embodiment, the rotation transmission mechanism 70 and the claws 46 are integrated to form a sub-assembly, and the sub-assembly is attached to the gripping portion 38. Specifically, the rotational portion 72, the claws 46, the power transmission mechanism 75, the telescopic rotational mechanism 76 and the second driving source 74 are integrated. According to this configuration, it possible to apply the claw 46 having the rotation transmission mechanism 70 to the existing gripping portion. In particular, since it is easily possible to adjust the size of the gripping mechanism 66 and the length of the claw 46, versatility is high.

In this embodiment, the telescopic rotational mechanism 76 includes: the first rotational shaft 94 connected to the output shaft 74a of the second driving source 74; the second rotational shaft 96 connected to the inlet rotating body 92a of the power transmission mechanism 75; and the telescopic rotational structure 98 that transmits rotation of the first rotational shaft 94 to the second rotational shaft 96. The telescopic rotational structure 98 supports the second rotational shaft 96 movably in the open-close direction relative to the first rotational shaft 94.

Specifically, the telescopic rotational structure 98 includes: the cylindrical outer member 104 provided on the shaft end of the first rotational shaft 94; the inner member 106 provided on the shaft end of the second rotational shaft 96 and inserted into a hollow hole of the outer member 104; and the rolling element 108 interposed between the outer member 104 and the inner member 106. The rolling element 108 transmits rotation of the outer member 104 to the inner member 106 and supports the inner member 106 movably in the open-close direction relative to the outer member 104. According to this configuration, it is possible to securely transmit rotational torque in the rotational direction and to move smoothly in the telescopic direction with low resistance.

In this embodiment, the second driving source 74 is an electric motor. When an electric motor is used as the second driving source 74, it is possible to easily change the posture of the workpiece W to have any desired inclination. In addition to being able to invert the front and the back of the workpiece W, it is possible to change the inclination of the workpiece W freely. Thus, it is possible to cope with cases where it is preferable that the angle of the claw 46 is inclined at a predetermined angle relative to the workpiece W such as a case where the workpiece W is transported in the state where the workpiece W is inclined at any angle rather than flat, or a case where the workpiece W has notches to be gripped. Further, it is possible to easily cope with the case where the workpiece W should be placed at a predetermined angle after gripping the workpiece W.

In this embodiment, the power transmission mechanism 75 has the timing belt 90. According to this configuration, the length from the second driving source 74 to the rotational portion 72 can be easily changed, which increases the degree of the freedom in arranging the second driving source 74.

In the example in FIG. 11A, the second driving source 74 is fixed to the gripping portion main body 69. However, the second driving source 74 may be provided on the claw 46. In this case, load in the open-close direction increases due to the second driving source 74. However, the second driving source 74 can be directly connected to the rotational portion 72, and therefore, the telescopic rotational mechanism 76 and the power transmission mechanism 75 can be omitted.

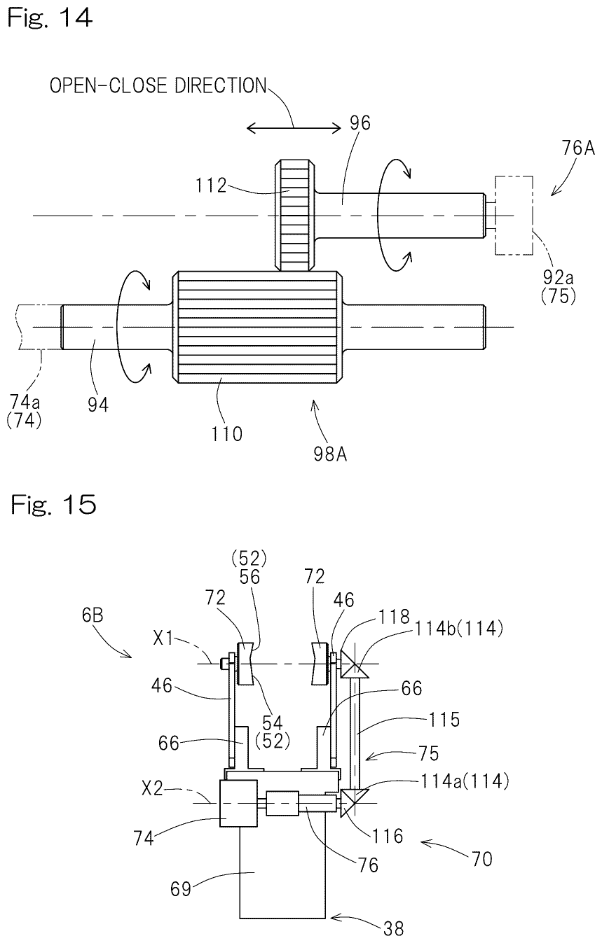

FIG. 14 illustrates a variation of a telescopic rotational structure 98A of a telescopic rotational mechanism 76A. The telescopic rotational structure 98A of the telescopic rotational mechanism 76A shown in FIG. 14 includes: a first gear 110 provided on the first rotational shaft 94 that has a long axial dimension; and a second gear 112 provided on the second rotational shaft 96 that has an axial dimension shorter than the that of the first gear 110.

The axial dimension of the first gear 110 is set to be longer than an open-close width of the gripping mechanism (FIG. 11A), i.e., a moving amount in the open-close direction. The first rotational shaft 94 and the first gear 110 are rotatable about the rotational axis of the second driving source 74 with respect to the gripping portion main body 69 (FIG. 11A). Further, the first rotational shaft 94 and the first gear 110 do not move in the open-close direction.

As the second gear 112 meshes with the first gear 110, rotation of the first gear 110 is transmitted to the second gear 112 and the second rotational shaft 96, and the second gear 112 and the second rotational shaft 96 are movable in the open-close direction (the axial direction).

According to this configuration, the first rotational shaft 94 and the first gear 110 rotate about the rotational axis by rotation of the second driving source 74, and the second gear 112 and the second rotational shaft 96 rotate by the meshing between the first gear 110 and the second gear 112. In addition, the second gear 112 and the second rotational shaft 96 move in a direction parallel to the open-close direction by the meshing between the first gear 110 and the second gear 112 in accordance with the opening and closing of the gripping mechanism 66 in FIG. 11A. This makes it possible to transmit rotational power to the rotational portion 72 at the tip end of the claw 46 even when the gripping mechanism 66 opens or closes. Thus, according to the variation in FIG. 14, with a small number of components, it is possible to securely transmit rotational torque in the rotational direction and to move in the telescopic direction.

In FIG. 14, the first gear 110 that has a long axial dimension is provided on the first rotational shaft 94, and the second gear 112 is provided on the second rotational shaft 96. However, the first gear 110 that has a long axial dimension may be provided on the second rotational shaft 96, and the second gear 112 may be provided on the first rotational shaft 94.

FIG. 15 illustrates a gripping device (hand) 6B according to variation of this embodiment. In the variation of FIG. 15, the power transmission mechanism 75 has a rod 115 having bevel gears 114 at both ends. The bevel gear 114 may be a “straight gear” or a “helical gear”.

The rod 115 extends between the rotational axis X2 of the second driving source 74 and the rotational axis X1 of the rotational portion 72 in a direction orthogonal to the both axes X1, X2. The bevel gear 114 has a primary bevel gear 114a on the second driving source 74 side and a secondary bevel gear 114b on the rotational portion 72 side.

A driving-side bevel gear 116 is provided at the tip end of the telescopic rotational mechanism 76 of the second rotational shaft 96, and meshed with the primary bevel gear 114a. The driving-side bevel gear 116 is arranged coaxially with the rotational axis X2 of the second driving source 74, and rotation of the second driving source 74 is transmitted to the driving-side bevel gear 116 via the telescopic rotational mechanism 76. In other words, in the variation of FIG. 15, the primary bevel gear 114a constitutes an inlet rotating body of the power transmission mechanism 75 to which the second rotational shaft 96 of the telescopic rotational mechanism 76 is connected.

A driven-side bevel gear 118 is provided at the tip end of t shaft body 80 of the rotational portion 72, and meshes with the secondary bevel gear 114b. The driven-side bevel gear 118 is arranged coaxially with the rotational axis X1 of the rotational portion 72, and rotation of the second driving source 74 is transmitted to the driven-side bevel gear 118 via the rotation transmission mechanism 70. In this way, the power of the second driving source 74 is transmitted to the rotational portion 72.

In the variation of FIG. 15, the length from the second driving source 74 to the rotational portion 72 can be easily changed by using the rod 115 having bevel gears 114 at both ends as the power transmission mechanism 75, which increases the degree of the freedom in arranging the second driving source 74.

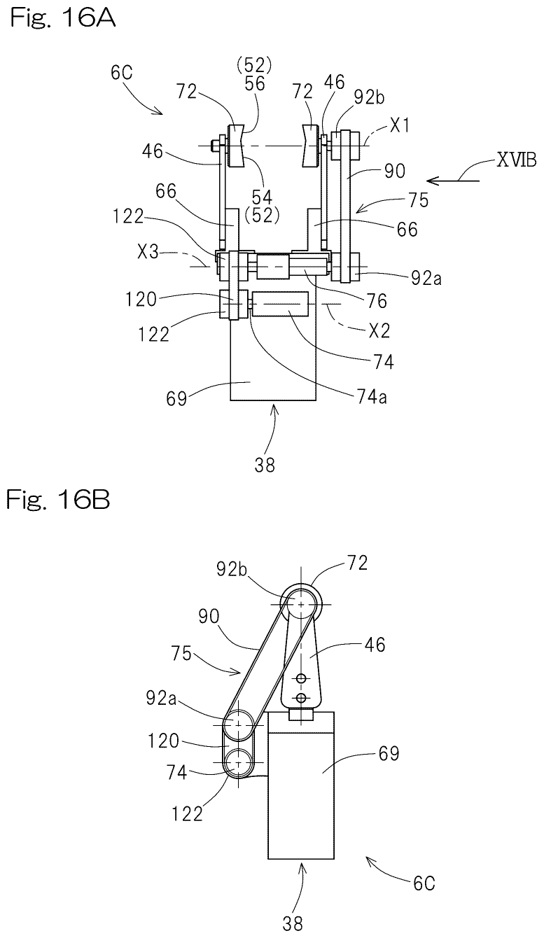

FIGS. 16A and 16B illustrate a gripping device (hand) 6C according to another variation of this embodiment. In the example of FIGS. 11A and 11B, the output shaft 74a of the second driving source 74 is directly connected to the first rotational shaft 94 of the telescopic rotational mechanism 76, and the telescopic rotational mechanism 76 is arranged coaxially with the rotational axis X2 of the second driving source 74. However, in the variation of FIGS. 16A and 16B, the output shaft 74a of the second driving source 74 is connected to the first rotational shaft 94 of the telescopic rotational mechanism 76 via a belt 120 and a pair of pulleys 122, 122. Thus, the rotational axis X2 of the second driving source 74 does not correspond to a rotational axis X3 of the telescopic rotational mechanism 76.

Specifically, one pulley 122 is provided on the output shaft 74a of the second driving source 74, and the other pulley 122 is provided on the first rotational shaft 94 of the telescopic rotational mechanism 76. The belt 120 is stretched over both pulley 122, 122. In this way, rotation of the second driving source 74 is transmitted to the telescopic rotational mechanism 76. Other structures are the same as those of the example of FIGS. 11A and 11B.

According to the variation of FIGS. 16A and 16B, a dimension of the gripping portion main body 69 of the gripping portion 38 in the open-close direction can be reduced compared to a configuration in which the telescopic rotational mechanism 76 is arranged coaxially with the second driving source 74 as shown in FIGS. 11A and 11B. This can suppress interference between the hand 6B and peripheral objects. In the variation of FIGS. 16A and 16B, the second driving source 74 is connected to the telescopic rotational mechanism 76 by a combination of the pulleys 122 and the belt 120. However, the second driving source 74 may be connected to the telescopic rotational mechanism 76 via a combination of a sprocket and a chain or a combination of multiple gears may be used.

As the power transmission mechanism 75, in the example of FIGS. 11A and 11B and the example of FIGS. 16A and 16B, a configuration in which the belt 90 and the pulley 92 are combined is used, and in the example of FIG. 15, a configuration in which the bevel gear 114 and the rod 115 are combined is used. However, as the power transmission mechanism 75, a configuration in which multiple spur gears are combined may be used.

In this embodiment, the tip end side angle α is set to be smaller than the base end side angle β (α<β). However, depending on the shape of the workpiece, the tip end side angle α may be set to be the same as the base end side angle β (α=β), or the tip end side angle α is set to be larger than the base end side angle β (α>β)

The embodiment of FIGS. 11A-16B includes the following aspects 1-10.

### Aspects 1

A hand comprising:
a plurality of claws that grips or releases a workpiece;
a gripping portion which moves the claw in a gripping direction for gripping the workpiece and in a releasing direction for releasing the workpiece; and
a rotation transmission mechanism that rotates the workpieces gripped by the claw about a rotational axis parallel to the gripping direction and the releasing direction, wherein
the claw is supported at its base end by the gripping portion so as be movable in the gripping direction and the releasing direction, has a gripping surface gripping the workpiece at its tip end, and extends in an extending direction from the base end to the tip end, and
the gripping surface has:
   a first inclined surface which extends in an inclined condition in the releasing direction from a base end in the extending direction toward a tip end side in the extending direction; and
   a second inclined surface which extends in an inclined condition in the releasing direction from a tip end in the extending direction toward a base end side in the extending direction.

### Aspects 2

The hand according to aspect 1, wherein, seen in an orthogonal direction which is orthogonal to the extending direction in the open-close direction, a tip end side angle α between a tip end side virtual line drawn by extending the second inclined surface to the tip end side and a horizontal conveyance surface of the conveyance carrier is set to be smaller than a base end side angle β between a base end side virtual line drawn by extending the first inclined surface to the base end side and a parallel line parallel to the conveyance surface.

### Aspects 3

The hand according to aspect 1, wherein, seen in the orthogonal direction which is orthogonal to the extending direction in the open-close direction, the tip end side angle α between the tip end side virtual line drawn by extending the second inclined surface to the tip end side and the horizontal conveyance surface of the conveyance carrier is set to be larger than the base end side angle β between the base end side virtual line drawn by extending the first inclined surface to the base end side and the parallel line parallel to the conveyance surface.

### Aspects 4

The hand according to any one of aspects 1 to 3, wherein a friction coefficient of at least one of the first inclined surface and the second inclined surface is 0.2 or less.

### Aspects 5

The hand according to any one of aspects 1 to 4, wherein
the rotation transmission mechanism includes:
   a rotational portion provided at the tip end of the claw so as to be rotatable to the claw about the rotational axis parallel to the open-close direction; and
   a second driving source which rotatably drives the rotational portion about the rotational axis, and
the gripping surface is formed on the rotational portion.

### Aspects 6

The hand according to aspect 5, wherein
the rotation transmission mechanism and the claws are integrated to form a sub-assembly, and
the sab-assembly is attached to the gripping portion.

### Aspects 7

The hand according to aspect 5 or 6, wherein the rotation transmission mechanism further includes:
a power transmission mechanism that is connected to at least one of the rotational portions, power transmission mechanism moving with the rotational portion in the gripping direction and the releasing direction and transmitting the power of the second driving source to the rotational portion; and
a telescopic rotational mechanism that is telescopic in the gripping direction and the releasing direction and transmits rotation of the second driving source to the power transmission mechanism.

### Aspects 8

The hand according to aspect 7, wherein the telescopic rotational mechanism includes:
a first rotational shaft connected to an output shaft of the second driving source;
a second rotational shaft connected to an inlet rotating body of the power transmission mechanism; and
a telescopic rotational structure that transmits rotation of the first rotational shaft to the second rotational shaft and supports the second rotational shaft movably in the gripping direction and the releasing direction relative to the first rotational shaft.

### Aspects 9

The hand according to aspect 8, wherein the telescopic rotational structure includes:
a cylindrical outer member provided on either a shaft end of the first rotational shaft or the second rotational shaft;
an inner member provided on another shaft end of the first rotational shaft or the second rotational shaft and inserted into a hollow hole of the outer member; and
a rolling element interposed between the outer member and the inner member, the rolling element transmitting rotation of the outer member to the inner member and supporting the member provided on the second rotational shaft movably in the gripping direction and the releasing direction relative to the member provided on the first rotational shaft.

### Aspects 10

The hand according to aspect 8, wherein the telescopic rotational structure includes:
a first gear provided on either the first rotational shaft or the second rotational shaft, the first gear having an axial dimension longer than an open-close width of the gripping portion; and
a second gear provided on another one of the first rotational shaft a the second rotational shaft, the second gear transmitting rotation of the first gear by meshing with the first gear and being movable in the gripping direction and the releasing direction relative to the first gear.

The present invention is not limited to the above-described embodiments, and various additions, changes, or deletions can be made without departing from the gist of the present invention. Therefore, these are construed as included within the scope of the present invention.

### Reference Symbols

2 · · · parts feeder
4 · · · robot
6, 6A, 6B, 6C · · · hand
8 · · · conveyance carrier
10 · · · arm
16 · · · vibrating bowl feeder
18 · · · bowl
18a · · · conveying path
20 · · · standing wall
22 · · · rotating disk
22a · · · conveyance surface
38 · · · gripping portion
40 · · · actuator
44 · · · connecting member
46 · · · claw
48 · · · fragile part
52 · · · gripping surface
54 · · · first inclined surface
56 · · · second inclined surface
70 · · · rotation transmission mechanism
72 · · · rotational portion
74 · · · second driving source
75 · · · power transmission mechanism
76 · · · telescopic rotational mechanism
94 · · · first rotational shaft
96 · · · second rotational shaft
98 · · · telescopic rotational structure
104 · · · outer member
106 · · · inner member
108 · · · rolling element
110 · · · first gear
112 · · · second gear
α · · · tip end side angle
β · · · base end side angle
A1 · · · first area
A2 · · · second area
D1 · · · longitudinal direction
D2 · · · open-close direction
D3 · · · orthogonal direction
SY · · · component supply system
W · · · workpiece

What is claimed is:

1. A hand comprising:
a claw that grips or releases a workpiece; and
a gripping portion which moves the claw in a gripping direction for gripping the workpiece and in a releasing direction for releasing the workpiece, wherein
the claw is supported at its base end by the gripping portion so as be movable in the gripping direction and the releasing direction, extends in a longitudinal direction from the gripping portion, and has a gripping surface gripping the workpiece at its tip end,
the gripping surface has: a first inclined surface which extends in an inclined condition in the releasing direction from its base end in the longitudinal direction toward a tip end side in the longitudinal direction; and
a second inclined surface which extends in an inclined condition in the releasing direction from its tip end in the longitudinal direction toward a base end side in the longitudinal direction so as to be continued to the first inclined surface, and
seen in an orthogonal direction which is orthogonal to each of the longitudinal direction, the gripping direction and the releasing direction, a tip end side angle α between a tip end side virtual line drawn by extending the second inclined surface to the tip end side and a horizontal conveyance surface of the conveyance carrier is set to be smaller than a base end side angle β between a base end side virtual line drawn by extending the first inclined surface to the base end side and a parallel line parallel to the conveyance surface.

2. The hand as claimed in claim 1, wherein the tip end side angle α is set to be 25° or more and 30° or less, and the base end side angle β is greater than 50° and smaller than 60°.

3. The hand as claimed in claim 1, wherein a friction coefficient at least one of the first inclined surface and the second inclined surface is 0.2 or less.

4. The hand as claimed in claim 1 further comprises a rotation transmission mechanism which rotates the workpieces gripped by the claw about a rotational axis parallel to the gripping direction and the releasing direction.

5. The hand as claimed in claim 4, wherein
the rotation transmission mechanism includes: a rotational portion provided at the tip end of the claw to be rotatable to the claw about the rotational axis parallel to open-close direction; and a second driving source which rotatably drives the rotational portion about the rotational axis, and
the gripping surface is formed on the rotational portion.

6. The hand as claimed in claim 5, wherein
the rotation transmission mechanism and the claws are integrated to form a sub-assembly, and
the sub-assembly is attached to the gripping portion.

7. The hand as claimed in claim 5, wherein the rotation transmission mechanism further includes:
a power transmission mechanism that is connected to at least one of the rotational portions, moves with the rotational portion in the gripping direction and the releasing direction and transmits the power of the second driving source to the rotational portion; and
a telescopic rotational mechanism that is telescopic in the gripping direction and the releasing direction and transmits rotation of the second driving source to the power transmission mechanism.

8. The hand as claimed in claim 7, wherein the telescopic rotational mechanism includes:
a first rotational shaft connected to an output shaft of the second driving source;
a second rotational shaft connected to an inlet rotating body of the power transmission mechanism; and
a telescopic rotational structure that transmits rotation of the first rotational shaft to the second rotational shaft and supports the second rotational shaft movably in the gripping direction and the releasing direction relative to the first rotational shaft.

9. The hand as claimed in claim 8, wherein the telescopic rotational structure includes:
a cylindrical outer member provided on either a shaft end of the first rotational shaft or the second rotational shaft;
an inner member provided on another shaft end of the first rotational shaft or the second rotational shaft and inserted into a hollow hole of the outer member; and
a rolling element interposed between the outer member and the inner member, the rolling element transmitting rotation of the outer member to the inner member and supporting the member provided on the second rotational shaft movably in the gripping direction and the releasing direction relative to the member provided on the first rotational shaft.

10. The hand as claimed in claim 8, wherein the telescopic rotational structure includes:
a first gear provided on either the first rotational shaft or the second rotational shaft that has an axial dimension longer than an open-close width of the gripping portion; and
a second gear provided on another one of the first rotational shaft o the second rotational shaft, the second gear transmitting rotation of the first gear by meshing with the first gear and being movable in the gripping direction and the releasing direction relative to the first gear.

11. A component supply system comprising:
a parts feeder that feeds the workpiece to a conveyance carrier;
a robot that conveys the workpiece from a first area where the conveyance carrier is located to a second area different from the first area; and
a hand as claimed in claim 1, the hand being attached to a tip end o an arm of the robot, picking up the workpiece on the conveyance carrier at the first area and placing them on the second area.

12. The component supply system as claimed in claim 11, further comprising:
a workpiece detector that detects a position and posture of the workpiece on the conveyance carrier; and
a controller that synchronously controls the robot and the hands, wherein
the controller moves the arm of the robot to the position detected by the workpiece detector and makes the hand grip the workpiece at an angle corresponding to the posture detected by the workpiece detector.
